(19) United States
(12) Patent Application Publication
(10) Pub. No.: US 2021/0232144 A1
(43) Pub. Date: Jul. 29, 2021

(54) METHOD OF CONTROLLING ARTIFICIAL INTELLIGENCE ROBOT DEVICE

(71) Applicant: LG ELECTRONICS INC., Seoul (KR)

(72) Inventor: Kyoungwoo LEE, Seoul (KR)

(73) Assignee: LG ELECTRONICS INC., Seoul (KR)

(21) Appl. No.: 17/009,683

(22) Filed: Sep. 1, 2020

(30) Foreign Application Priority Data
Jan. 28, 2020 (KR) 10-2020-0010026

(51) Int. Cl. G05D 1/02; G05D 1/00; B60L 58/12; H04W 24/10; H04W 72/04; H04W 56/00; H04L 5/00; G06N 3/02

(52) U.S. Cl. CPC G05D 1/0217; G05D 1/0088; B60L 58/12; G06N 3/02; H04W 72/042; H04W 56/001; H04L 5/0053; H04W 24/10

(57) ABSTRACT

A method for controlling an artificial intelligence robot device may include identifying capacity information of a battery; obtaining driving information for at least one driving route for driving a target area; predicting power information of the battery of which power is consumed during moving through the driving route based on the obtained driving information and the capacity information of the battery; determining whether the driving route is completed based on a charge remaining state in the battery calculated by analyzing the predicted power information; and determining the driving route based on whether the driving route is completed. The artificial intelligence robot device according to the present disclosure may be linked with an Artificial Intelligence module, a drone (Unmanned Aerial Vehicle, UAV), a robot, an Augmented Reality (AR) device, a virtual reality (VR) device, a device related to 5G service, and the like.

### CROSS-REFERENCE TO RELATED APPLICATION(S)

Pursuant to 35 U.S.C. § 119(a), this application claims the benefit of earlier filing date and right of priority to Korean Patent Application No. 10-2020-0010026, filed on Jan. 28, 2020, the contents of which are hereby incorporated by reference herein in its entirety.

### BACKGROUND OF THE DISCLOSURE

### Field of the Invention

The present disclosure relates to a method for controlling an artificial intelligence robot device.

### Related Art

In recent years, with significant development of information communication technology and semiconductor technology, supply and use of various types of robot devices have rapidly increased. As the robot devices are widely supplied, a robot device supports various functions in conjunction with another robot device.

In order to support the various functions, a robot device needs much power, and for this, a battery related technology and a technology of controlling charge and discharge of battery have been vigorously researched.

### SUMMARY OF THE DISCLOSURE

The disclosure aims to address the foregoing issues and/or needs.

The present disclosure also provides a method for controlling an artificial intelligence robot device that may calculate an optimal charging time using consumption/charge amount of a battery power which is previously learned and completely or partially charge the battery until all of tasks are executed.

In an aspect, a method for controlling an artificial intelligence robot device may include identifying capacity information of a battery; obtaining driving information for at least one driving route for driving a target area; predicting power information of the battery of which power is consumed during moving through the driving route based on the obtained driving information and the capacity information of the battery; determining whether the driving route is completed based on a charge remaining state in the battery calculated by analyzing the predicted power information; and determining the driving route based on whether the driving route is completed.

Furthermore, the capacity information of the battery may include at least one of a life of the battery, a voltage of the battery, a charging time of the battery and a discharging time of the battery.

Furthermore, the step of obtaining driving information may further include: obtaining map information; configuring a target area in the obtained map information; configuring a partition area by partitioning the target area; configuring the driving route based on the partition area; and obtaining driving information for the configured driving route.

Furthermore, the driving route may be differently configured corresponding to a task of the artificial intelligence robot device.

Furthermore, the step of configuring the partition area may include partitioning the partition area based on a preconfigured partition criterion, wherein the preconfigured partition criterion may include at least one of an area, a moving distance and an accessibility.

Furthermore, the step of determining whether the driving route is completed may further include: extracting feature values from the power information obtained through at least one sensor; and inputting the feature values in an artificial neural network (ANN) sorter trained to identify whether the driving route is a completed route and determining whether the driving route is completed based on an output of the ANN.

Furthermore, the feature values may be values that distinguish whether the driving route is completed based on the charge remaining state in the battery.

Furthermore, the driving information may include at least one of peripheral environment of the driving route, a position of an obstacle, a slope of the driving route and a material of the driving route.

Furthermore, the method may further include: receiving Downlink Control Information (DCI) used for scheduling a transmission of the power information obtained from at least one sensor provided in the artificial intelligence robot device from a network, wherein the power information may be transmitted to the network based on the DCI.

Furthermore, the method may further include: performing an initial access process with the network based on Synchronization signal block (SSB), wherein the power information may be transmitted to the network through a PUSCH, and wherein the SSB and a DM-RS of the PUSCH may be QCLed with respect to QCL type D.

Furthermore, the method may further include: controlling a transceiver to transmit the power information to an AI processor included in the network; and controlling the transceiver to receive AI processed information from the AI processor, wherein the AI processed information may be information of determining the charge remaining state in the battery.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a conceptual diagram illustrating an embodiment of an AI device.

FIG. 2 illustrates a block diagram of a wireless communication system to which the methods proposed in the present disclosure may be applied.

FIG. 3 illustrates an example of a signal transmission/reception method in a wireless communication system.

FIG. 4 illustrates an example of a basic operation of a user equipment and a 5G network in a 5G communication system.

FIGS. 5 and 6 are perspective views illustrating an artificial intelligence robot device according to an embodiment of the present disclosure.

FIG. 7 is a block diagram illustrating a configuration of an artificial intelligence robot device.

FIG. 8 is a block diagram illustrating an AI device according to an embodiment of the present disclosure.

FIG. 9 is a diagram for describing a method for controlling an artificial intelligence robot device according to an embodiment of the present disclosure.

FIG. 10 is a diagram for describing a method for obtaining driving information according to an embodiment of the present disclosure.

FIG. 11 is a diagram for describing an example of determining a driving route by using an artificial intelligence robot device according to an embodiment of the present disclosure.

FIG. 12 is a diagram for describing another example of determining a driving route by using an artificial intelligence robot device according to an embodiment of the present disclosure.

FIG. 13 is a diagram for describing an example of briefly executing a cleaning work by using an artificial intelligence robot device according to an embodiment of the present disclosure.

FIG. 14 is a diagram for describing a consumption of battery power predicted for each partition area according to an embodiment of the present disclosure.

FIG. 15 is a diagram for describing an example of executing a cleaning work by using an artificial intelligence robot device according to an embodiment of the present disclosure.

FIG. 16 is a diagram for describing another example of a configuration of an artificial intelligence robot device according to an embodiment of the present disclosure.

FIG. 17 is a diagram for describing an example of briefly executing a lawn mowing cleaning work by using an artificial intelligence robot device according to an embodiment of the present disclosure.

FIG. 18 is a diagram for describing a consumption of battery power predicted for each partition area according to an embodiment of the present disclosure.

FIG. 19 is a diagram for describing an example of executing a lawn mowing work by using an artificial intelligence robot device according to an embodiment of the present disclosure.

FIG. 20 is a diagram for describing an example of briefly executing an airport guidance work by using an artificial intelligence robot device according to an embodiment of the present disclosure.

FIG. 21 is a diagram for describing a consumption of battery power predicted for each partition area according to an embodiment of the present disclosure.

FIG. 22 is a diagram for describing an example of executing an airport guidance work by using an artificial intelligence robot device according to an embodiment of the present disclosure.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

Three major requirement areas of 5G include (1) an enhanced mobile broadband (eMBB) area, (2) a massive machine type communication (mMTC) area, and (3) ultra-reliable and low latency communications (URLLC) area.

Some use cases may require multiple areas for optimization, and other use cases may be focused to only one key performance indicator (KPI). 5G supports these various use cases in a flexible and reliable manner.

The EMBB enables far beyond basic mobile Internet access and covers media and entertainment applications in rich interactive work, cloud or augmented reality. Data is one of key dynamic power of 5G, and in a 5G era, a dedicated voice service may not be seen for the first time. In 5G, a voice is expected to be treated as an application program using data connection simply provided by a communication system. Main reasons for an increased traffic volume are increase in content size and increase in the number of applications requiring a high data transmission rate. Streaming services (audio and video), interactive video, and mobile Internet connections will be used more widely as more devices connect to Internet. These many application programs require always-on connectivity in order to push real-time information and notifications to a user. Cloud storage and applications are growing rapidly in mobile communication platforms, which may be applied to both work and entertainment. Cloud storage is a special use case that drives growth of uplink data transmission rates. 5G is also used for remote tasks in cloud and requires much lower end-to-end delays so as to maintain excellent user experience when tactile interfaces are used. Entertainment, for example, cloud gaming and video streaming is another key factor in increasing the need for mobile broadband capabilities. Entertainment is essential in smartphones and tablets at anywhere including in high mobility environments such as trains, cars and airplanes. Another use case is augmented reality and information search for entertainment. Here, augmented reality requires very low latency and instantaneous amount of data.

Further, one of most anticipated 5G use cases relates to a function, i.e., mMTC that can smoothly connect embedded sensors in all fields. By 2020 year, potential IoT devices are expected to reach 20.4 billion. Industrial IoT is one of areas in which 5G plays a major role in enabling smart cities, asset tracking, smart utilities, and agriculture and security infrastructure.

URLLC includes new services to transform an industry through ultra-reliable/available low latency links, such as remote control of major infrastructure and self-driving vehicles. A level of reliability and latency is essential for smart grid control, industrial automation, robotics, drone control, and coordination.

Hereinafter, a number of use cases are described in more detail.

5G may complement fiber-to-the-home (FTTH) and cable-based broadband (or DOCSIS) as a means of providing streams that are rated at hundreds of megabits per second to gigabits per second. Such a high speed is required to deliver televisions with a resolution of 4K or more (6K, 8K, and more) as well as virtual reality and augmented reality. Virtual Reality (VR) and Augmented Reality (AR) applications include nearly immersive sporting events. A specific application program may require a special network setting. For example, for VR games, in order to minimize latency, game companies may need to integrate core servers with an edge network server of a network operator.

An automotive is expected to become important new dynamic power for 5G together with many use cases for mobile communication to vehicles. For example, entertainment for passengers requires simultaneous high capacity and high mobility mobile broadband. This is because future users continue to expect high quality connections regardless of a position and speed thereof. Another use case of an automotive sector is an augmented reality dashboard. This identifies objects in the dark above what a driver views through a front window and overlays and displays information that notifies the driver about a distance and movement of the object. In the future, wireless modules enable communication between vehicles, exchange of information between a vehicle and a supporting infrastructure, and exchange of information between a vehicle and other connected devices (e.g., devices carried by pedestrians). A safety system guides alternative courses of an action to enable drivers to safer drive, thereby reducing the risk of an accident. The next step will be a remotely controlled or self-driven vehicle. This requires very reliable and very fast communication between different self-driving vehicles and between automobiles and infrastructure. In the future, self-driving vehicles will perform all driving activities and the driver will focus on traffic anomalies that the vehicle itself cannot identify. The technical requirements of self-driving vehicles require ultra-low latency and ultra-fast reliability so as to increase traffic safety to an unachievable level.

Smart cities and smart homes, referred to as smart societies, will be embedded in a high density wireless sensor network. A distributed network of intelligent sensors will identify conditions for a cost and energy-efficient maintenance of a city or a home. Similar settings may be made for each family. Temperature sensors, window and heating controllers, burglar alarms and home appliances are all connected wirelessly. These many sensors are typically low data rates, low power and low cost. However, for example, real-time HD video may be required in a specific type of device for surveillance.

Consumption and distribution of energy including a heat or a gas is highly decentralized, thereby requiring automated control of distributed sensor networks. Smart grids interconnect these sensors using digital information and communication technology so as to collect information and act accordingly. The information may include a behavior of suppliers and consumers, allowing smart grids to improve distribution of fuels such as electricity in efficiency, reliability, economics, sustainability of production, and in an automated manner. Smart grid may be viewed as another sensor network with low latency.

A health sector has many application programs that can benefit from mobile communication. The communication system may support telemedicine that provides clinical care at a far distance. This may help reduce barriers to distance and improve access to healthcare services that are not consistently available in remote rural areas. It is also used for saving lives in important care and emergency situations. A mobile communication based wireless sensor network may provide remote monitoring and sensors for parameters such as a heart rate and a blood pressure.

Wireless and mobile communication is becoming gradually important in an industrial application field. A wiring requires a highly installing and maintaining cost. Therefore, the possibility of replacing with a wireless link that can reconfigure a cable is an attractive opportunity in many industry fields. However, achieving this requires that a wireless connection operates with reliability, capacity, and delay similar to a cable and that management is simplified. Low latency and very low error probability are new requirements that need to be connected in 5G.

Logistics and freight tracking are important use cases for mobile communication that enable tracking of inventory and packages at anywhere using a position-based information system. A use case of logistics and freight tracking typically requires a low data rate, but requires reliable position information and a wide range.

The present disclosure to be described later in the present disclosure may be implemented by combining or changing each embodiment so as to satisfy the requirements of the above-described 5G.

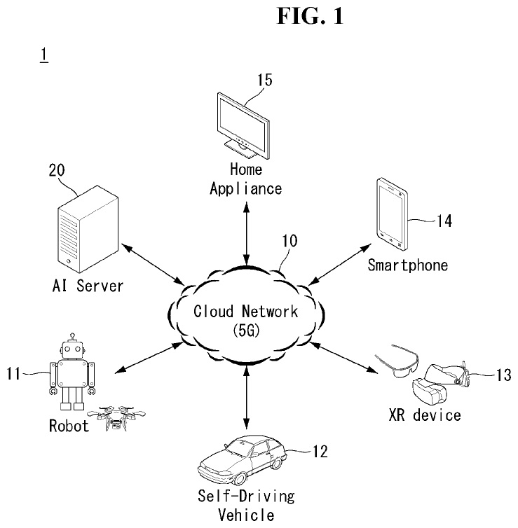

FIG. 1 is a conceptual diagram illustrating an embodiment of an AI device.

Referring to FIG. 1, in an AI system, at least one of an AI server 20, a robot 11, an autonomous vehicle 12, an XR device 13, a smartphone 14, or a home appliance 15 is connected to a cloud network 10. Here, the robot 11, the autonomous vehicle 12, the XR device 13, the smartphone 14, or the home appliance 15 to which AI technology is applied may be referred to as AI devices 11 to 15.

The cloud network 10 may mean a network that configures part of a cloud computing infrastructure or that exists inside a cloud computing infrastructure. Here, the cloud network 10 may be configured using a 3G network, a 4G network, a long term evolution (LTE) network, or a 5G network.

That is, each device 11 to 15 and 20 constituting the AI system may be connected to each other through the cloud network 10. In particular, each of the devices 11 to 15 and 20 may communicate with each other through a base station, but may directly communicate with each other without passing through a base station.

The AI server 20 may include a server that performs AI processing and a server that performs operations on big data.

The AI server 20 may be connected to at least one of the robot 11, the autonomous vehicle 12, the XR device 13, the smartphone 14, or the home appliance 15, which are AI devices constituting the AI system through the cloud network 10 and may help at least some of AI processing of the connected AI devices 11 to 15.

In this case, the AI server 20 may learn an artificial neural network according to machine learning algorithm instead of the AI devices 11 to 15 and directly store a learning model or transmit a learning model to the AI devices 11 to 15.

In this case, the AI server 20 may receive input data from the AI devices 11 to 15, infer a result value of the input data received using a learning model, and generate a response or a control command based on the inferred result value to transmit the response or the control command to the AI device s11 and 15.

Alternatively, the AI devices 11 to 15 may directly infer a result value of the input data using a learning model and generate a response or a control command based on the inferred result value.

<AI+Robot>

AI technology is applied to the robot 11, and the robot 11 may be implemented into a guide robot, a transport robot, a cleaning robot, a wearable robot, an entertainment robot, a pet robot, an unmanned aerial robot, or the like.

The robot 11 may include a robot control module for controlling an operation, and the robot control module may mean a software module or a chip implemented in hardware.

The robot 11 may obtain status information of the robot 11 using sensor information obtained from various kinds of sensors, detect (recognize) a surrounding environment and an object, generate map data, determine a moving route and a driving plan, determine a response to a user interaction, or determine an operation.

Here, in order to determine a movement route and a driving plan, the robot 11 may use sensor information obtained from a sensor of at least one of rider, radar, and a camera.

The robot 11 may perform the above operation using a learning model configured with at least of one artificial neural network. For example, the robot 11 may recognize a surrounding environment and an object using a learning model, and determine an operation using the recognized surrounding environment information or object information. Here, the learning model may be directly learned by the robot 11 or may be learned by an external device such as the AI server 20.

In this case, by generating a result directly using a learning model, the robot 11 may perform an operation, but may transmit sensor information to an external device such as the AI server 20 and receive the generated result and perform an operation.

The robot 11 may determine a movement route and a driving plan using at least one of map data, object information detected from sensor information, or object information obtained from an external device, and control a driver to drive the robot 11 according to the determined movement route and driving plan.

The map data may include object identification information about various objects disposed in a space in which the robot 11 moves. For example, the map data may include object identification information about fixed objects such as walls and doors and movable objects such as flower pots and desks. The object identification information may include a name, a kind, a distance, and a position.

Further, by controlling the driver based on the control/interaction of a user, the robot 11 may perform an operation or may drive. In this case, the robot 11 may obtain intention information of an interaction according to the user's motion or voice utterance, and determine a response based on the obtained intention information to perform an operation.

<AI+Autonomous Vehicle>

AI technology is applied to the autonomous vehicle 12 and thus the autonomous vehicle 12 may be implemented into a mobile robot, a vehicle, an unmanned aerial vehicle, or the like.

The autonomous vehicle 12 may include an autonomous driving control module for controlling an autonomous driving function, and the autonomous driving control module may mean a software module or a chip implemented in hardware. The autonomous driving control module may be included inside the autonomous vehicle 12 as a configuration of the autonomous vehicle 12, but may be configured as a separate hardware to be connected to the outside of the autonomous vehicle 12.

The autonomous vehicle 12 may obtain status information thereof using sensor information obtained from various types of sensors, detect (recognize) a surrounding environment and object, generate map data, determine a moving route and a driving plan, or determine an operation.

Here, in order to determine a movement route and a driving plan, the autonomous vehicle 12 may use sensor information obtained from a sensor of at least one of rider, radar, and a camera, similar to the robot 11.

In particular, the autonomous vehicle 12 may recognize an environment or an object about an area in which a field of view is covered or an area of a predetermined distance or more by receiving sensor information from external devices or may directly receive recognized information from external devices.

The autonomous vehicle 12 may perform the above-described operations using a learning model configured with at least one artificial neural network. For example, the autonomous vehicle 12 may recognize a surrounding environment and an object using a learning model, and determine a driving route using the recognized surrounding environment information or object information. Here, the learning model may be learned directly from the autonomous vehicle 12 or may be learned from an external device such as the AI server 20.

In this case, by generating a result directly using a learning model, the autonomous vehicle 12 may perform an operation, but transmit sensor information to an external device such as the AI server 20 and thus receive the generated result to perform an operation.

The autonomous vehicle 12 may determine a moving route and a driving plan using at least one of map data, object information detected from sensor information, or object information obtained from an external device, and controls the driver to drive the autonomous vehicle 12 according to the determined moving route and driving plan.

The map data may include object identification information about various objects disposed in a space (e.g., road) in which the autonomous vehicle 12 drives. For example, the map data may include object identification information about fixed objects such as street lights, rocks, buildings, and movable objects such as vehicles and pedestrians. The object identification information may include a name, a kind, a distance, a position, and the like.

Further, by controlling the driver based on a user's control/interaction, the autonomous vehicle 12 may perform an operation or may drive. In this case, the autonomous vehicle 12 may obtain intention information of an interaction according to the user's motion or voice utterance, and determine a response based on the obtained intention information to perform an operation.

<AI+XR>

AI technology is applied to the XR device 13 and thus the XR device 13 may be implemented into a head-mount display (HMD), a head-up display (HUD) installed in a vehicle, a television, a mobile phone, a smartphone, a computer, a wearable device, a home appliance, digital signage, a vehicle, a fixed robot, or a mobile robot.

The XR device 13 may analyze three-dimensional point cloud data or image data obtained through various sensors or from an external device to generate position data and attribute data of the three-dimensional points, thereby obtaining information about a surrounding space or a reality object and rendering and outputting an XR object to output. For example, the XR device 13 may output an XR object including additional information about the recognized object to correspond to the recognized object.

The XR device 13 may perform the above-described operations using a learning model configured with at least one artificial neural network. For example, the XR device 13 may recognize a real object in 3D point cloud data or image data using the learning model, and provide information corresponding to the recognized real object. Here, the learning model may be learned directly from the XR device 13 or may be learned from an external device such as the AI server 20.

In this case, by generating a result directly using a learning model, the XR device 13 may perform an operation, but transmit sensor information to an external device such as the AI server 20 and receive the generated result to perform an operation.

<AI+Robot+Autonomous Driving>

AI technology and autonomous driving technology are applied to the robot 11 and thus the robot 11 may be implemented into a guide robot, a transport robot, a cleaning robot, a wearable robot, an entertainment robot, a pet robot, an unmanned aerial robot, or the like.

The robot 11 to which AI technology and autonomous driving technology are applied may mean a robot having an autonomous driving function or a robot 11 interacting with the autonomous vehicle 12.

The robot 11 having an autonomous driving function may be collectively referred to as devices that moves by themselves according to a given moving route without a user's control or that determine and move a moving route by themselves.

In order to determine at least one of a movement route or a driving plan, the robot 11 and the autonomous vehicle 12 having an autonomous driving function may use a common sensing method. For example, the robot 11 and the autonomous vehicle 12 having the autonomous driving function may determine at least one of a movement route or a driving plan using information sensed through lidar, radar, and the camera.

While the robot 11 interacting with the autonomous vehicle 12 exists separately from the autonomous vehicle 12, the robot 11 may be linked to an autonomous driving function inside or outside the autonomous vehicle 12 or may perform an operation connected to a user who rides in the autonomous vehicle 12.

In this case, the robot 11 interacting with the autonomous vehicle 12 may obtain sensor information instead of the autonomous vehicle 12 to provide the sensor information to the autonomous vehicle 12 or may obtain sensor information and generate surrounding environment information or object information to provide the surrounding environment information or the object information to the autonomous vehicle 12, thereby controlling or assisting an autonomous driving function of the autonomous vehicle 12.

Alternatively, the robot 11 interacting with the autonomous vehicle 12 may monitor a user who rides in the autonomous vehicle 12 or may control a function of the autonomous vehicle 12 through an interaction with the user. For example, when it is determined that a driver is in a drowsy state, the robot 11 may activate an autonomous driving function of the autonomous vehicle 12 or assist the control of the driver of the autonomous vehicle 12. Here, the function of the autonomous vehicle 12 controlled by the robot 11 may include a function provided by a navigation system or an audio system provided inside the autonomous vehicle 12 as well as an autonomous driving function.

Alternatively, the robot 11 interacting with the autonomous vehicle 12 may provide information from the outside of the autonomous vehicle 12 to the autonomous vehicle 12 or assist a function of the autonomous vehicle 12. For example, the robot 11 may provide traffic information including signal information to the autonomous vehicle 12 as in a smart traffic light and interact with the autonomous vehicle 12 to automatically connect an electric charger to a charging port, as in an automatic electric charger of an electric vehicle.

<AI+Robot+XR>

AI technology and XR technology are applied to the robot 11, and the robot 11 may be implemented into a guide robot, a transport robot, a cleaning robot, a wearable robot, an entertainment robot, a pet robot, an unmanned aerial robot, a drone, or the like.

The robot 11 to which the XR technology is applied may mean a robot to be an object of control/interaction in an XR image. In this case, the robot 11 may be distinguished from the XR device 13 and be interworked with the XR device 13.

When the robot 11 to be an object of control/interaction in the XR image obtains sensor information from sensors including a camera, the robot 11 or the XR device 13 generates an XR image based on the sensor information, and the XR device 13 may output the generated XR image. The robot 11 may operate based on a control signal input through the XR device 13 or a user interaction.

For example, the user may check an XR image corresponding to a viewpoint of the robot 11 remotely linked through an external device such as the XR device 13, and adjust an autonomous driving route of the robot 11 through an interaction, control an operation or driving of the robot 11, or check information of a surrounding object.

<AI+Autonomous Vehicle+XR>

AI technology and XR technology are applied to the autonomous vehicle 12, and the autonomous vehicle 12 may be implemented into a mobile robot, a vehicle, an unmanned aerial vehicle, and the like.

The autonomous vehicle 12 to which XR technology is applied may mean an autonomous vehicle having a means for providing an XR image or an autonomous vehicle to be an object of control/interaction in the XR image. In particular, the autonomous vehicle 12 to be an object of control/interaction in the XR image may be distinguished from the XR device 13 and be interworked with the XR device 13.

The autonomous vehicle 12 having a means for providing an XR image may obtain sensor information from sensors including a camera, and output an XR image generated based on the obtained sensor information. For example, by having an HUD and outputting an XR image, the autonomous vehicle 12 may provide an XR object corresponding to a real object or an object on a screen to an occupant.

In this case, when the XR object is output to the HUD, at least a part of the XR object may be output to overlap with the actual object to which the occupant's eyes are directed. However, when the XR object is output to the display provided inside the autonomous vehicle 12, at least a part of the XR object may be output to overlap with an object on the screen. For example, the autonomous vehicle 12 may output XR objects corresponding to objects such as a road, another vehicle, a traffic light, a traffic sign, a motorcycle, a pedestrian, a building, and the like.

When the autonomous vehicle 12 to be an object of control/interaction in the XR image obtains sensor information from sensors including a camera, the autonomous vehicle 12 or the XR device 13 may generate an XR image based on the sensor information, and the XR device 13 may output the generated XR image. The autonomous vehicle 12 may operate based on a user's interaction or a control signal input through an external device such as the XR device 13.

[EXtended Reality (XR) Technology]

EXtended Reality (XR) collectively refers to Virtual Reality (VR), Augmented Reality (AR), and Mixed Reality (MR). VR technology is computer graphic technology that provides an object or a background of a real world only to CG images, AR technology is computer graphic technology that together provides virtual CG images on real object images, and MR technology is computer graphic technology that provides by mixing and combining virtual objects in a real world.

MR technology is similar to AR technology in that it shows both a real object and a virtual object. However, there is a difference in that in AR technology, a virtual object is used in the form of supplementing a real object, but in MR technology, a virtual object and a real object are used in an equivalent nature.

XR technology may be applied to a Head-Mount Display (HMD), a Head-Up Display (HUD), a mobile phone, a tablet PC, a laptop computer, a desktop computer, a television, digital signage, etc. and a device to which XR technology is applied may be referred to an XR device.

A. Example of block diagram of UE and 5G network

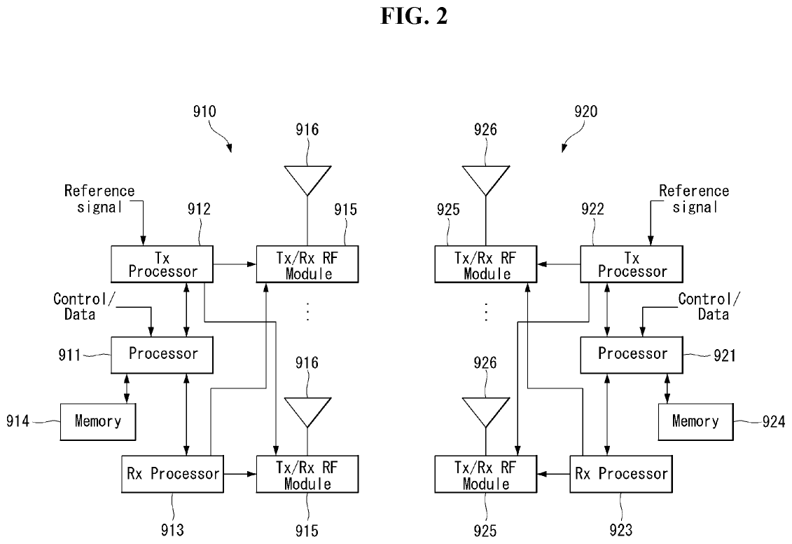

FIG. 2 is a block diagram of a wireless communication system to which methods proposed in the disclosure are applicable.

Referring to FIG. 2, a device (AI device) including an AI module is defined as a first communication device (910), and a processor 911 can perform detailed autonomous operations.

A 5G network including another device (AI server) communicating with the AI device is defined as a second communication device (920), and a processor 921 can perform detailed autonomous operations.

The 5G network may be represented as the first communication device and the AI device may be represented as the second communication device.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 2, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

According to an embodiment of the present disclosure, the first communication device may be an intelligent electronic device, and the second communication device may be a 5G network.

B. Signal Transmission/Reception Method in Wireless Communication System

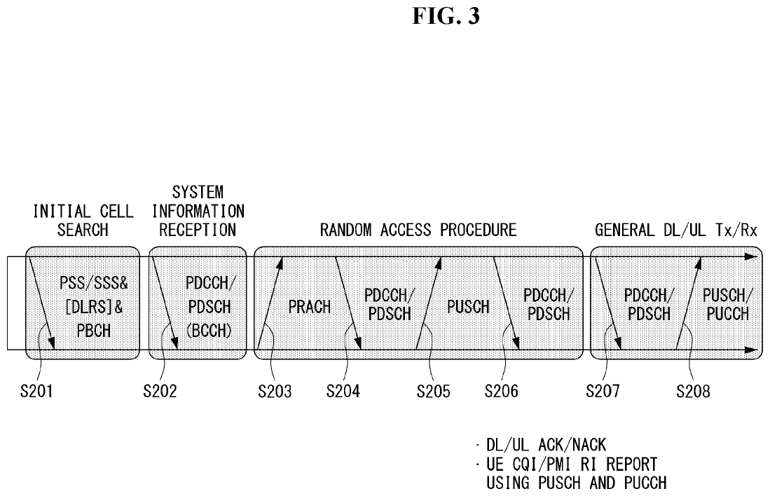

FIG. 3 is a diagram showing an example of a signal transmission/reception method in a wireless communication system.

In a wireless communication system, a UE receives information from a base station through downlink (DL), and the UE transmits information to the base station through uplink (UL). The information transmitted and received by the base station and the UE includes data and various control information, and various physical channels exist according to a kind/use of information in which the base station and the UE transmit and receive.

When power of the UE is turned on or when the UE newly enters to a cell, the UE performs an initial cell search operation of synchronizing with the base station (S201). For this reason, the UE may receive a primary synchronization signal (PSS) and a secondary synchronization signal (SSS) from the base station to be synchronized with the base station and obtain information such as cell ID. Thereafter, the UE may receive a physical broadcast channel (PBCH) from the base station to obtain broadcast information within the cell. The UE may receive a downlink reference signal (DL RS) in an initial cell search step to check a downlink channel status.

The UE, having finished initial cell search may receive a physical downlink shared channel (PDSCH) according to a physical downlink control channel (PDCCH) and information loaded in the PDCCH to obtain more specific system information (S202).

When the UE first accesses to the base station or when there is no radio resource for signal transmission, the UE may perform a random access procedure (RACH) to the base station (S203 to S206). For this reason, the UE may transmit a specific sequence to a preamble through a physical random access channel (PRACH) (S203 and S205) and receive a random access response (RAR) message to the preamble through the PDCCH and the PDSCH corresponding thereto. In the case of a contention-based RACH, the UE may additionally perform a contention resolution procedure (S206).

The UE, having performed the above process may perform PDCCH/PDSCH reception (S207) and physical uplink shared channel (PUSCH)/physical uplink control channel (PUCCH) transmission (S208) as a general uplink/downlink signal transmission procedure. In particular, the UE receives downlink control information (DCI) through the PDCCH. Here, the DCI includes control information such as resource allocation information for the UE and may be applied in different formats according to a use purpose.

Control information transmitted by the UE to the base station through uplink or received by the UE from the base station may include a downlink/uplink ACK/NACK signal, a channel quality indicator (CQI), a precoding matrix index (PMI), and a rank indicator (RI). The UE may transmit control information such as the above-described CQI/PMI/RI through a PUSCH and/or a PUCCH.

The UE monitors a set of PDCCH candidates at monitoring occasions set to at least one control element sets (CORESETs) on a serving cell according to the corresponding search space configurations. A set of PDCCH candidates to be monitored by the UE is defined in terms of search space sets, and the search space sets may be a common search space set or a UE-specific search space set. The CORESET is configured with a set of (physical) resource blocks having time duration of 1 to 3 OFDM symbols. The network may set the UE to have a plurality of CORESETs. The UE monitors PDCCH candidates in at least one search space sets. Here, monitoring means attempting to decode the PDCCH candidate(s) in the search space. When the UE succeeds in decoding one of PDCCH candidates in a search space, the UE determines that the PDCCH has been detected in the corresponding PDCCH candidate, and performs PDSCH reception or PUSCH transmission based on DCI in the detected PDCCH. The PDCCH may be used for scheduling DL transmissions on the PDSCH and UL transmissions on the PUSCH. Here, DCI on the PDCCH includes a downlink assignment (i.e., downlink grant (DL grant)) including at least modulation and coding format and resource allocation information related to a downlink shared channel or uplink grant (UL grant) including modulation and coding format and resource allocation information related to an uplink shared channel.

An initial access (IA) procedure in a 5G communication system will be additionally described with reference to FIG. 3.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 3.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCelllD, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation of AI Using 5G Communication

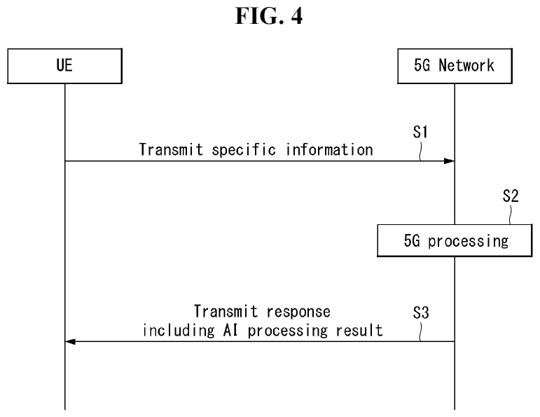

FIG. 4 shows an example of basic operations of an UE and a 5G network in a 5G communication system.

The UE transmits specific information to the 5G network (S1). The 5G network may perform 5G processing related to the specific information (S2). Here, the 5G processing may include AI processing. And the 5G network may transmit response including AI processing result to UE (S3).

G. Applied Operations Between UE and 5G Network in 5G Communication System

Hereinafter, the operation of an AI using 5G communication will be described in more detail with reference to wireless communication technology (BM procedure, URLLC, mMTC, etc.) described in FIGS. 2 and 3.

First, a basic procedure of an applied operation to which a method proposed by the present disclosure which will be described later and eMBB of 5G communication are applied will be described.

As in steps S1 and S3 of FIG. 4, the UE performs an initial access procedure and a random access procedure with the 5G network prior to step S1 of FIG. 4 in order to transmit/receive signals, information and the like to/from the 5G network.

More specifically, the UE performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the UE receives a signal from the 5G network.

In addition, the UE performs a random access procedure with the 5G network for UL synchronization acquisition and/or UL transmission. The 5G network can transmit, to the UE, a UL grant for scheduling transmission of specific information. Accordingly, the UE transmits the specific information to the 5G network on the basis of the UL grant. In addition, the 5G network transmits, to the UE, a DL grant for scheduling transmission of 5G processing results with respect to the specific information. Accordingly, the 5G network can transmit, to the UE, information (or a signal) related to remote control on the basis of the DL grant.

Next, a basic procedure of an applied operation to which a method proposed by the present disclosure which will be described later and URLLC of 5G communication are applied will be described.

As described above, an UE can receive DownlinkPreemption IE from the 5G network after the UE performs an initial access procedure and/or a random access procedure with the 5G network. Then, the UE receives DCI format 2_1 including a preemption indication from the 5G network on the basis of DownlinkPreemption IE. The UE does not perform (or expect or assume) reception of eMBB data in resources (PRBs and/or OFDM symbols) indicated by the preemption indication. Thereafter, when the UE needs to transmit specific information, the UE can receive a UL grant from the 5G network.

Next, a basic procedure of an applied operation to which a method proposed by the present disclosure which will be described later and mMTC of 5G communication are applied will be described.

Description will focus on parts in the steps of FIG. 4 which are changed according to application of mMTC.

In step S1 of FIG. 4, the UE receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the UE transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present disclosure which will be described later and applied or can complement the methods proposed in the present disclosure to make technical features of the methods concrete and clear.

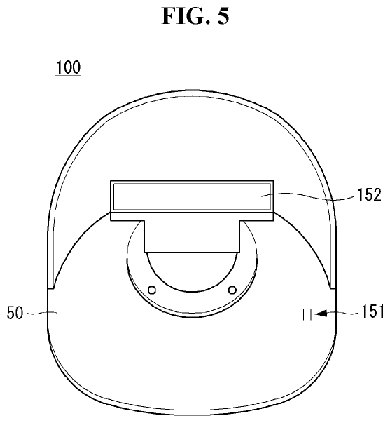

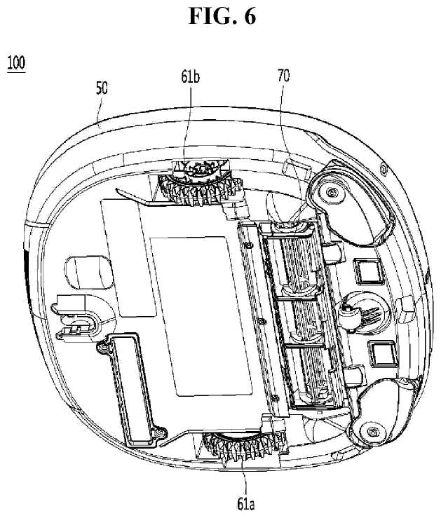

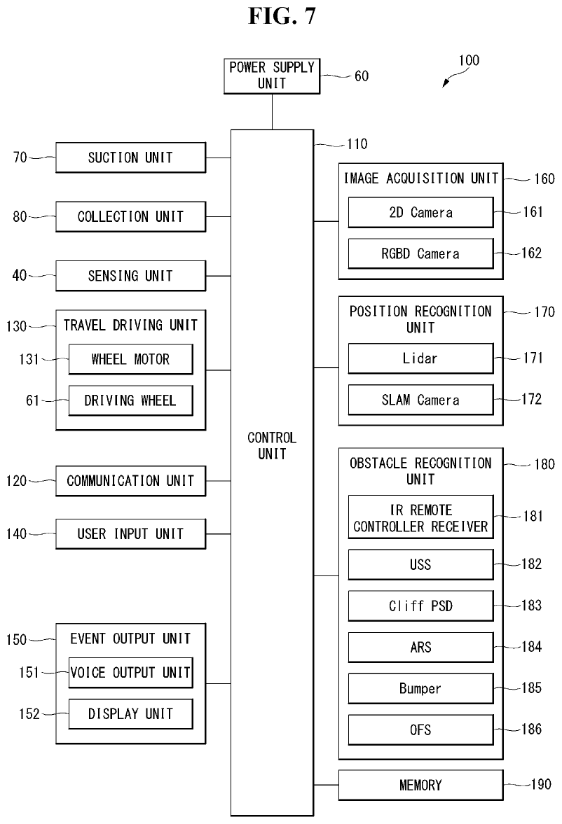

FIGS. 5 and 6 are perspective views of an intelligent robot cleaner in accordance with an embodiment of the present disclosure. FIG. 5 is a perspective view of the intelligent robot cleaner in accordance with the embodiment of the present disclosure when seen from above. FIG. 6 is a perspective view of the intelligent robot cleaner in accordance with the embodiment of the present disclosure when seen from below. FIG. 7 is a block diagram showing the configuration of the intelligent robot cleaner in accordance with the embodiment of the present disclosure.

Referring to FIGS. 5 to 7, the intelligent robot cleaner 100 in accordance with the embodiment of the present disclosure may include a housing 50, a sensing unit 40, a suction unit 70, a collection unit 80, a power supply unit 60, a control unit 110, a communication unit 120, a travel driving unit 130, a user input unit 140, an event output unit 150, an image acquisition unit 160, a position recognition unit 170, an obstacle recognition unit 180 and a memory 190.

The housing 50 may provide a space in which internal components are installed, and may define the appearance of the intelligent robot cleaner 100. The housing 50 may protect the components installed in the intelligent robot cleaner 100 from being protected from an outside.

The power supply unit 60 may include a battery driver and a lithium-ion battery. The battery driver may manage the charging or discharging of the lithium-ion battery. The lithium-ion battery may supply power for driving the robot. The lithium-ion battery may be made by connecting two 24V/102A lithium-ion batteries in parallel.

The suction unit 70 may suck dust or foreign matter from a cleaning target region. The suction unit 70 may use the principle of forcing air to flow using a fan that is rotated by a motor or the like.

The collection unit 80 may be connected to the suction unit 70 via a predetermined pipe. The collection unit 80 may include a predetermined space to collect dust, foreign matter or an article sucked through the suction unit 70. The collection unit 80 may be detachably mounted on the housing 50. The collection unit 80 may collect the dust, the foreign matter or the article sucked through the suction unit 70 while the collection unit is mounted on the housing 50. The collection unit 80 may be detached from the housing 50 to take out or throw away the collected dust, foreign matter or article. The collection unit 80 may be referred to as a dust box, a foreign-matter container or the like.

The sensing unit 40 may be mounted on the housing 50 and may primarily sense the foreign matter sucked through the suction unit 70 under the control of the control unit 110 that will be described later. If articles other than the foreign matter are sensed, the sensing unit may secondarily sense the articles collected in the collection unit 80. This will be described below in detail.

The control unit 110 may include a microcomputer to control the power supply unit 60 including the battery in a hardware of the intelligent robot cleaner 100, the obstacle recognition unit 180 including various sensors, the travel driving unit 130 including a plurality of motors and wheels, the sensing unit 40 and the collection unit 80.

The control unit 110 may include an application processor (AP) to perform the function of controlling an entire system of a hardware module of the intelligent robot cleaner 100. The control unit 110 may be referred to as a processor. The AP is intended to drive an application program for the travel using position information acquired via various sensors and to drive the motor by transmitting user input/output information to the microcomputer. Furthermore, the user input unit 140, the image acquisition unit 160, the position recognition unit 170 and the like may be controlled by the AP.

Furthermore, the control unit 110 may include the AI processor 111. The AI processor 111 may learn a neural network using a program stored in the memory 190. Particularly, the AI processor 111 may learn a neural network for recognizing an article sensed by the intelligent robot cleaner 100. Here, the neural network may include a deep learning model developed from a neural network model. While a plurality of network nodes is located at different layers in the deep learning model, the nodes may exchange data according to a convolution connecting relationship. Examples of the neural network model include various deep learning techniques, such as a deep neural network (DNN), a convolution neural network (CNN), a recurrent neural network (RNN, Recurrent Boltzmann Machine), a restricted Boltzmann machine (RBM,), a deep belief network (DBN) or a deep Q-Network, and may be applied to fields such as computer vision, voice recognition, natural language processing, voice/signal processing or the like.

The intelligent robot cleaner 100 may implement the function of analyzing an image for all or a part of an article sensed by the sensing unit 40 and extracting the characteristics of the article, by applying the deep learning model through the AI processor 111. Alternatively, the intelligent robot cleaner 100 may implement the function of analyzing the image of a object acquired by the image acquisition unit 160, recognizing the position of the object and recognizing an obstacle, by applying the deep learning model through the AI processor 111. The intelligent robot cleaner 100 may implement at least one of the above-described functions by receiving the AI processing result from an external server through the communication unit.

The communication unit 120 may further include a component receiving a signal/data from external input, and various additional components, such as a wireless communication module (not shown) for wireless communication or a tuner (not shown) for tuning a broadcast signal, according to the design method of the intelligent robot cleaner 100. The communication unit 120 may not only receive a signal from an external device, but also may transmit the information/data/signal of the intelligent robot cleaner 100 to the external device. That is, the communication unit 120 may be implemented as an interface facilitating two-way communication, without being limited to only the configuration of receiving the signal of the external device. The communication unit 120 may receive a control signal for selecting an UI from a plurality of control devices. The communication unit 120 may include wireless communication, wire communication and mobile communication modules. For example, the communication unit 120 may be configured as a communication module for known near field wireless communication, such as wireless LAN (WiFi), Bluetooth, Infrared (IR), Ultra Wideband (UWB) or Zigbee. The communication unit 120 may be configured as a mobile communication module such as 3G, 4G, LTE or 5G communication modules. The communication unit 120 may be configured as a known communication port for wire communication. The communication unit 120 may be used for various purposes. For example, the communication unit may be used to transmit and receive a control signal for selecting the UI, a command for manipulating a display, or data.

The travel driving unit 130 may include a wheel motor 131 and a driving wheel 61. The driving wheel 61 may include first and second driving wheels 61a and 61b. The wheel motor 131 may control the first driving wheel 61a and the second driving wheel 61b. The wheel motor 131 may be driven under the control of the travel driving unit 130. The first driving wheel 61a and the second driving wheel 61b fastened to the wheel motor 131 may be individually separated. The first driving wheel 61a and the second driving wheel 61b may be operated independently from each other. Thus, the intelligent robot cleaner 100 may be moved forwards/backwards and rotated in either direction.

The user input unit 140 may transmit various control commands or information, which are preset by a user's manipulation and input, to the control unit 110. The user input unit 140 may be made as a menu-key or an input panel provided on an outside of the intelligent robot cleaner, a remote controller separated from the intelligent robot cleaner 100 or the like. Alternatively, some components of the user input unit 140 may be integrated with a display unit 152. The display unit 152 may be a touch-screen. For example, a user touches an input menu displayed on the display unit 152 that is the touch-screen to transmit a preset command to the control unit 110.

The user input unit 140 may sense a user's gesture through the sensor that senses an interior of the region and transmit his or her command to the control unit 110. Alternatively, the user input unit 140 may transmit a user's voice command to the control unit 110 to perform an operation and setting.

When a object is extracted from an image acquired through the image acquisition unit 160 or other event situations occur, the event output unit 150 may be configured to inform a user of the event situation. The event extraction unit 150 may include a voice output unit 151 and the display unit 152.

The voice output unit 151 may output a pre-stored voice message when a specific event occurs.

The display unit 152 may display a pre-stored message or image when a specific event occurs. The display unit 152 may display the driving state of the intelligent robot cleaner 100 or display additional information, such as the date/time/temperature/humidity of a current state.

The image acquisition unit 160 may include a 2D camera 161 and a RGBD camera 162. The 2D camera 161 may be a sensor for recognizing a person or an article based on a 2D image. The RGBD (Red, Green, Blue and Distance) camera 162 may be a sensor for detecting a person or an article using captured images having depth data acquired from a camera having RGBD sensors or other similar 3D imaging devices.

The image acquisition unit 160 may provide, image data acquired by photographing foreign matter or an article sucked through the intelligent robot cleaner 100 or image data acquired by photographing collected foreign matter or article, to the control unit 110. The control unit 110 may re-sense the foreign matter or article based on the image data.

Furthermore, the image acquisition unit 160 may acquire the image on the travel path of the intelligent robot cleaner 100 and then provide the acquired image data to the control unit 110. The control unit 110 may reset the travel path based on the acquired image data.

The position recognition unit 170 may include a light detection and ranging (lidar) 171 and a simultaneous localization and mapping (SLAM) camera 172.

The SLAM camera may implement concurrent position tracking and mapping techniques. The intelligent robot cleaner 100 may detect information about surrounding environment using the SLAM camera 172 and then may process the obtained information to prepare a map corresponding to a mission execution space and simultaneously estimate the absolute position of the cleaner.

The lidar 171 is a laser radar, and may be a sensor that radiates a laser beam, collects and analyzes backscattered light among light absorbed or scattered by an aerosol to recognize a position.

The position recognition unit 170 may process sensing data collected from the lidar 171 and the SLAM camera 172 to manage data for recognizing the robot's position and the obstacle.

The obstacle recognition unit 180 may include an IR remote controller receiver 181, an USS 182, a Cliff PSD 183, an ARS 184, a bumper 185, and an OFS 186.

The IR remote controller receiver 181 may include a sensor that receives a signal of the IR (infrared) remote controller to remotely control the intelligent robot cleaner 100.

The ultrasonic sensor (USS) 182 may include a sensor to determine a distance between the obstacle and the robot using an ultrasonic signal.

The Cliff PSD 183 may include a sensor to sense a cliff or a precipice in a travel range of the intelligent robot cleaner 100 in all directions at 360 degrees.

The attitude reference system (ARS) 184 may include a sensor to detect the attitude of the robot. The ARS 184 may include a sensor configured as three axes of acceleration and three axes of gyro to detect the rotating amount of the intelligent robot cleaner 100.

The bumper 185 may include a sensor to sense a collision between the intelligent robot cleaner 100 and the obstacle. The sensor included in the bumper 185 may sense the collision between the intelligent robot cleaner 100 and the obstacle in a range of 360 degrees.

The optical flow sensor (OFS) 186 may include a sensor that may measure the travel distance of the intelligent robot cleaner 100 on various floor surfaces and a phenomenon in which the intelligent robot cleaner 100 runs idle during the travel.

The memory 190 may store a name of an article corresponding to the obstacle, image information corresponding thereto, and various image information about the article collected by the collection unit 80.

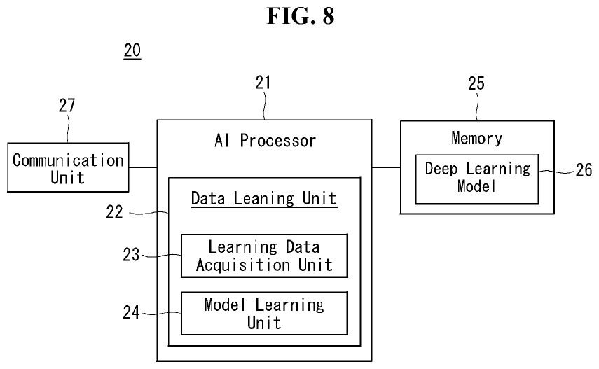

FIG. 8 is a block diagram of an AI device in accordance with the embodiment of the present disclosure.

The AI device 20 may include electronic equipment that includes an AI module to perform AI processing or a server that includes the AI module. Furthermore, the AI device 20 may be included in at least a portion of the intelligent robot cleaner 100 illustrated in FIG. 7, and may be provided to perform at least some of the AI processing.

The AI processing may include all operations related to the function of the intelligent robot cleaner 100 illustrated in FIG. 5. For example, the intelligent robot cleaner may AI-process sensing data or travel data to perform processing/determining and a control-signal generating operation. Furthermore, for example, the intelligent robot cleaner may AI-process data acquired through interaction with other electronic equipment provided in the intelligent robot cleaner to control sensing.

The AI device 20 may include an AI processor 21, a memory 25 and/or a communication unit 27.

The AI device 20 may be a computing device capable of learning a neural network, and may be implemented as various electronic devices such as a server, a desktop PC, a laptop PC or a tablet PC.

The AI processor 21 may learn the neural network using a program stored in the memory 25. Particularly, the AI processor 21 may learn the neural network for recognizing data related to the intelligent robot cleaner 100. Here, the neural network for recognizing data related to the intelligent robot cleaner 100 may be designed to simulate a human brain structure on the computer, and may include a plurality of network nodes having weights that simulate the neurons of the human neural network. The plurality of network nodes may exchange data according to the connecting relationship to simulate the synaptic action of neurons in which the neurons exchange signals through synapses. Here, the neural network may include the deep learning model developed from the neural network model. While the plurality of network nodes is located at different layers in the deep learning model, the nodes may exchange data according to the convolution connecting relationship. Examples of the neural network model include various deep learning techniques, such as a deep neural network (DNN), a convolution neural network (CNN), a recurrent neural network (RNN, Recurrent Boltzmann Machine), a restricted Boltzmann machine (RBM,), a deep belief network (DBN) or a deep Q-Network, and may be applied to fields such as computer vision, voice recognition, natural language processing, voice/signal processing or the like.

Meanwhile, the processor performing the above-described function may be a general-purpose processor (e.g. CPU), but may be an AI dedicated processor (e.g. GPU) for artificial intelligence learning.

The memory 25 may store various programs and data required to operate the AI device 20. The memory 25 may be implemented as a non-volatile memory, a volatile memory, a flash memory), a hard disk drive (HDD) or a solid state drive (SDD). The memory 25 may be accessed by the AI processor 21, and reading/writing/correcting/deleting/update of data by the AI processor 21 may be performed.

Furthermore, the memory 25 may store the neural network model (e.g. the deep learning model 26) generated through a learning algorithm for classifying/recognizing data in accordance with the embodiment of the present disclosure.

The AI processor 21 may include a data learning unit 22 which learns the neural network for data classification/recognition. The data learning unit 22 may learn a criterion about what learning data is used to determine the data classification/recognition and about how to classify and recognize data using the learning data. The data learning unit 22 may learn the deep learning model by acquiring the learning data that is used for learning and applying the acquired learning data to the deep learning model.

The data learning unit 22 may be made in the form of at least one hardware chip and may be mounted on the AI device 20. For example, the data learning unit 22 may be made in the form of a dedicated hardware chip for the artificial intelligence AI, and may be made as a portion of the general-purpose processor (CPU) or the graphic dedicated processor (GPU) to be mounted on the AI device 20. Furthermore, the data learning unit 22 may be implemented as a software module. When the data learning unit is implemented as the software module (or a program module including instructions), the software module may be stored in a non-transitory computer readable medium. In this case, at least one software module may be provided by an operating system (OS) or an application.

The data learning unit 22 may include the learning-data acquisition unit 23 and the model learning unit 24.

The learning-data acquisition unit 23 may acquire the learning data needed for the neural network model for classifying and recognizing the data. For example, the learning-data acquisition unit 23 may acquire vehicle data and/or sample data which are to be inputted into the neural network model, as the learning data.

The model learning unit 24 may learn to have a determination criterion about how the neural network model classifies predetermined data, using the acquired learning data. The model learning unit 24 may learn the neural network model, through supervised learning using at least some of the learning data as the determination criterion. Alternatively, the model learning unit 24 may learn the neural network model through unsupervised learning that finds the determination criterion, by learning by itself using the learning data without supervision.

Furthermore, the model learning unit 24 may learn the neural network model through reinforcement learning using feedback on whether the result of situation determination according to the learning is correct. Furthermore, the model learning unit 24 may learn the neural network model using the learning algorithm including error back-propagation or gradient descent.

If the neural network model is learned, the model learning unit 24 may store the learned neural network model in the memory. The model learning unit 24 may store the learned neural network model in the memory of the server connected to the AI device 20 with a wire or wireless network.

The data learning unit 22 may further include a learning-data preprocessing unit (not shown) and a learning-data selection unit (not shown) to improve the analysis result of the recognition model or to save resources or time required for generating the recognition model.

The learning-data preprocessing unit may preprocess the acquired data so that the acquired data may be used for learning for situation determination. For example, the learning-data preprocessing unit may process the acquired data in a preset format so that the model learning unit 24 may use the acquired learning data for learning for image recognition.

Furthermore, the learning-data selection unit may select the data required for learning among the learning data acquired by the learning-data acquisition unit 23 or the learning data preprocessed in the preprocessing unit. The selected learning data may be provided to the model learning unit 24. For example, the learning-data selection unit may select only data on the object included in a specific region as the learning data, by detecting the specific region in the image acquired by the camera of the intelligent robot cleaner 100.

Furthermore, the data learning unit 22 may further include a model evaluation unit (not shown) to improve the analysis result of the neural network model.

When the model evaluation unit inputs evaluated data into the neural network model and the analysis result outputted from the evaluated data does not satisfy a predetermined criterion, the model learning unit 22 may learn again. In this case, the evaluated data may be predefined data for evaluating the recognition model. By way of example, the model evaluation unit may evaluate that the predetermined criterion is not satisfied when the number or ratio of the evaluated data in which the analysis result is inaccurate among the analysis result of the learned recognition model for the evaluated data exceeds a preset threshold.

The communication unit 27 may transmit the AI processing result by the AI processor 21 to the external electronic equipment.

Here, the external electronic device may be defined as an artificial intelligence robot device. Furthermore, the AI device 20 may be defined as another artificial intelligence robot device or 5G network which communicates with the artificial intelligence robot device. Meanwhile, the AI device 20 may also be implemented with being functionally embedded in a driving module provided in the robot device. In addition, the 5G network may include a server or a module that performs a driving related control.

Although the AI device 20 illustrated in FIG. 8 is functionally divided into the AI processor 21, the memory 25, the communication unit 27 and the like, it is to be noted that the above-described components are integrated into one module, which is referred to as an AI module.

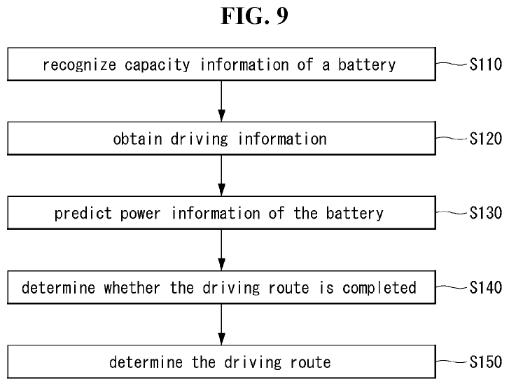

FIG. 9 is a diagram for describing a method for controlling an artificial intelligence robot device according to an embodiment of the present disclosure.

Referring to FIG. 9, an artificial intelligence robot device may recognize capacity information of a battery under a control of a processor (step, S110). For example, the capacity information of the battery may include a life of the battery, a voltage of the battery, a charging time of the battery, a discharging time of the battery, and the like. The processor may recognize power information of the battery for using the battery power totally based on the capacity information of the battery which is charged in the battery.

The processor may obtain driving information for at least one driving route for driving a target area (step, S120). The processor may obtain driving information for a plurality of driving routes for driving the target area based on the driving information which is stored or learned in advance. A plurality of driving routes may be a route for driving all areas of the target area sequentially or selectively.

A plurality of driving routes may be differently configured corresponding to a task of the artificial intelligence robot device. For example, in the case that a task of the artificial intelligence robot device is cleaning, a plurality of driving routes may be configured based on an area in which dust or waste is frequently occurred among the target area. In the case that a task of the artificial intelligence robot device is lawn mowing, a plurality of driving routes may be configured so as to drive all areas of the target area thoroughly. In the case that a task of the artificial intelligence robot device is an airport guidance, a plurality of driving routes may be configured based on an area in which many tourists or airport users are located among the target area.

The processor may predict power information of the battery of which power is consumed during moving through the driving route based on the obtained driving information (step, S130). The power information of the battery may be power capacity information of the battery for totally using the battery power. The power information of the battery may include a consumption amount of the battery power including a time or an amount for which the battery power is consumed. The driving information may include peripheral environment of the driving route, a position of an obstacle, a slope of the driving route, a material of the driving route, and the like.

For example, in the case that the artificial intelligence robot device drives 10 meters through a normal driving route, the processor may predict that a consumption amount of the battery power is 10. Accordingly, in the case that the artificial intelligence robot device drives 10 meters through a normal driving route, the processor may calculate a consumption amount of the battery power to be 100.

The processor may differently predict a consumption amount of the battery power corresponding to the obtained driving route. For example, in the case of sloped driving route or a driving route including may obstacles, not a normal driving route, the processor may predict that an amount of the battery power is more rapidly consumed.

The processor may analyze capacity information and power information of the battery and determine whether the driving route is completed based on the analysis result (step, S140). The processor may diagnose a charge remaining state in the battery relatively accurately by analyzing and learning the obtained capacity information and the power information. The processor may recognize the charge remaining state in the battery currently charged based on the analysis result, and the artificial intelligence robot device may select a drivable driving route among all driving routes in the target area. This will be described below in detail.

The processor may determine the driving route based on the determination result (step, S150). The processor may determine the driving route through which the artificial intelligence robot device may drive completely based on the charge remaining state in the battery or determine the driving route for driving completely after fully charging or recharging.

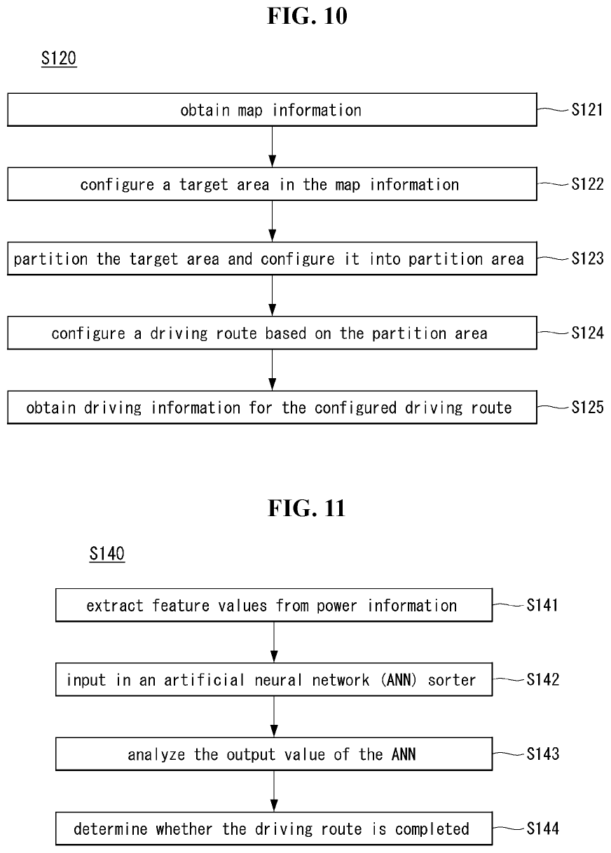

FIG. 10 is a diagram for describing a method for obtaining driving information according to an embodiment of the present disclosure.

Referring to FIG. 10, an artificial intelligence robot device may configure a target area based on map information and obtaining driving information by configuring the driving route based on a partition area by partitioning the target area.

A processor may obtain map information (step, S121). A transceiver disposed in the artificial intelligence robot device may be provided with the map information from an external device under a control of the processor. The external device may include an external server, a database (DB), and the like.

The processor may configure a target area in the obtained map information (step, S122). The processor may analyze the map information and obtain a target area based on the analyzed map information. The processor may configure the obtained target area corresponding to a task operation of the artificial intelligence robot device.

The processor may partition the target area and configure it into partition area (step, S123). The processor may partition the configured target area into at least one partition. The processor may partition the partition area based on a preconfigured partition criterion. The preconfigured partition criterion may include an area, a moving distance, an accessibility, and the like. For example, in the case that the preconfigured partition criterion is an area, the processor may configure a partition area based on an area. For example, in the case that an area of the target area is 100 m², the processor may partition the target area into a first partition area to a fifth partition area such that the areas are the same. Each of the first partition area to the fifth partition area may be partitioned into an area of 20 m², respectively.

In the case that an area of the target area is 100 m², the processor may partition the target area into a first partition area to a fourth partition area such that the areas are different. The processor may partition the target area into the first partition area to the fourth partition area by considering a moving distance or an accessibility, but the areas may be different. The first partition area may have an area of 10 m², and the second partition area may have an area of 20 m². The third partition area may have an area of 30 m², and the fourth partition area may have an area of 40 m². The detailed description therefor is described below.

The processor may configure a driving route based on the partition area (step, S124). The processor may generate at least one driving routes based on the configured partition areas. For example, the processor may generate at least one driving routes in the first partition area, generate at least one driving routes in the second partition area, generate at least one driving routes in the third partition area and generate at least one driving routes in the fifth partition area.

The processor may compare and analyze the generated driving routes and determine or configure the most suitable driving route for each of the partition areas. The processor may configure or determine a driving route for working a task of the artificial intelligence robot device efficiently.

The processor may obtain driving information for the configured driving route (step, S125). For example, the driving information may include a peripheral environment of the driving route, a position of an obstacle, a slope of the driving route, a material of the driving route, and the like. The processor may store the driving information obtained through the driving route in real time.

FIG. 11 is a diagram for describing an example of determining a driving route by using an artificial intelligence robot device according to an embodiment of the present disclosure.

Referring to FIG. 11, a processor 110 may extract feature values from power information obtained through at least one sensor for determining a charge remaining state in a battery (step, S141).

For example, the processor 110 may receive power information from at least one sensor (e.g., a charge sensor or a discharge sensor). The processor 110 may extract feature values from power information. The feature values may be values that distinguish whether the driving route is completed based on the charge remaining state in the battery among at least one feature which is extractable from the power information.

The processor 110 may control the feature values to be input in an artificial neural network (ANN) sorter trained to identify whether the driving route is a completed route (step, S142).

The processor 110 may generate a route selection input to which the extracted feature value is combined. The route selection input may be input to the artificial neural network (ANN) sorter trained such that the artificial intelligence robot device identifies whether the driving route is a completed route based on the extracted feature value. The completed route may be a completable route among a plurality of driving routes.

The processor 110 may analyze the output value of the ANN (step, S143) and determine a completed route based on the output value of the ANN (step, S144). The processor may distinguish or select a completed route among a plurality of driving routes from the output value of the ANN.

Meanwhile, in FIG. 11, it is described an example that the operation of distinguishing or selecting a completed route among a plurality of driving routes through an AI processing is implemented in the artificial intelligence robot device 100, but the present disclosure is not limited thereto. For example, the AI processing may be performed on a 5G network based on diagnosis information received from the artificial intelligence robot device 100.

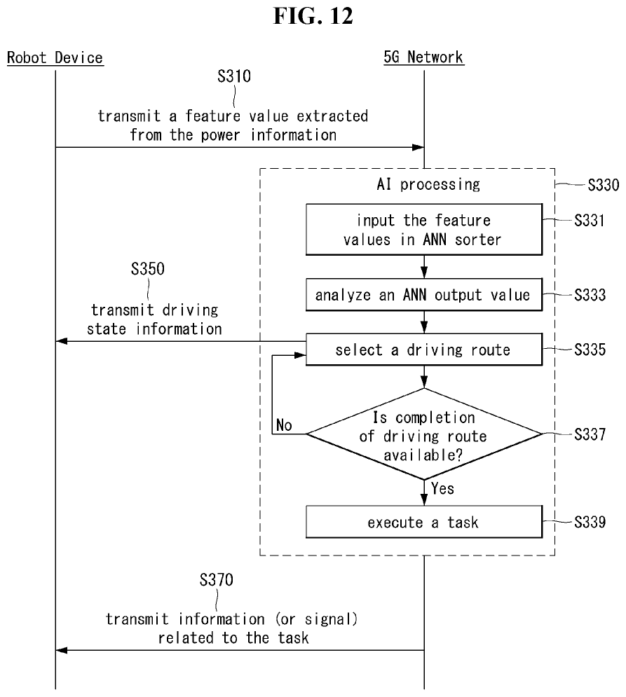

FIG. 12 is a diagram for describing another example of determining a driving route by using an artificial intelligence robot device according to an embodiment of the present disclosure.

The processor 110 may control a transceiver to transmit power information of a battery to an AI processor. In addition, the processor 110 may control the transceiver to receive AI processed information from the AI processor.

The AI processed information may be information of determining a charge remaining state in the battery.

Meanwhile, the artificial intelligence robot device 100 may perform an initial access process to a 5G network to transmit the power information of the battery to the 5G network. The artificial intelligence robot device 100 may perform an initial access process with the 5G network based on Synchronization signal block (SSB).

In addition, the artificial intelligence robot device 100 may receive Downlink Control Information (DCI) used for scheduling a transmission of the power information obtained from at least one sensor provided in the artificial intelligence robot device 100 from a network through a wireless communication unit.

The processor 110 may transmit the power information to the network based on the DCI.

The power information of the battery may be transmitted to the network through a PUSCH, and the SSB and a DM-RS of the PUSCH are QCLed with respect to QCL type D.

Referring to FIG. 12, the artificial intelligence robot device 100 may transmit a feature value extracted from the power information to a 5G network (step, S310).

Here, the 5G network may include an AI processor or an AI system, and the AI system of the 5G network may perform an AI processing based on the received power information (step, S330).

The AI system may input the feature values received from the artificial intelligence robot device 100 in an ANN sorter (step, S331). The AI system may analyze an ANN output value (step, S333) and select a driving route among a plurality of driving routes configured based on a charge remaining state in the battery from the ANN output value (step, S335).

The 5G network may transmit the driving information for the driving route determined in the AI system to the artificial intelligence robot device 100 through a transceiver. Here, the driving information may include information required for driving the driving route.

In the case that the AI system determines a completion of the selected driving route to be available (step, S337), the AI system may control to determine a driving route to be the completable route.

In the case that the driving route is the completable route, the AI system may control a task of the artificial intelligence robot device to be executed (step, S339). In addition, the AI system may transmit information (or signal) related to the task of the artificial intelligence robot device to the artificial intelligence robot device 100 (step, S370).

Meanwhile, the artificial intelligence robot device 100 may transmit only the power information to the 5G network and extract a feature value corresponding to a route selection input which is to be used as an input of artificial neural network for determining a completable route from the power information in the AI system included in the 5G network.

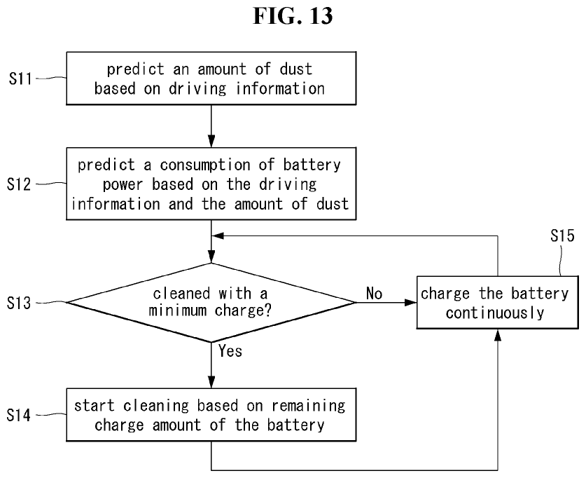

FIG. 13 is a diagram for describing an example of briefly executing a cleaning work by using an artificial intelligence robot device according to an embodiment of the present disclosure.

Referring to FIG. 13, a processor may predict an amount of dust for a partition area based on driving information (step, S11). For example, the driving information may include a weather, a time and a location. These may be learning elements. For example, the weather of the driving information may be information for yellow dust or fine dust obtained by using internet information. The time of the driving information may be time information classified for each time zone such as morning, afternoon and evening. The location of the driving information may be location information for a kitchen, a living room, a moving distance, and the like. The processor may learn an amount of dust for each partition area based on a driving element or a learning element and predict it.

The processor may predict a consumption of battery power consumed while driving through a driving route which is configured in a partition area based on the driving information and the amount of dust (step, S12). The consumption of battery power may be referred to as a decrement of battery power. In other words, the processor may predict an amount of battery power used while driving through a driving route which is configured in a partition area based on the driving information and the predicted amount of dust. Accordingly, the processor may recognize or calculate a charge remaining state in the battery by using amount information of battery power and the predicted amount of battery power or the consumption of battery power.

The processor may learn information for an amount of dust obtained by driving through a previous partition area, whether information, an active time of user and information for an area of the partition area and predict an amount of dust based on the learned information. The processor may learn the amount of battery power or the consumption of battery power based on the predicted amount of dust and predict it.

The processor may determine whether to clean at least one partition area among the partition areas based on the calculated or recognized charge remaining state in the battery (step, S13). That is, the processor may determine whether to clean one partition area among the partition areas with a minimum charge which is charged in the battery.

In the case that the processor determines that the determined remaining charge amount of the battery is available to clean at least one partition area (step, S13), the processor may move the artificial intelligence robot device to the partition area and start cleaning (step, S14).

On the other hand, in the case that the processor determines that the determined remaining charge amount of the battery is unavailable to clean at least one partition area (step, S13), the processor may charge the battery continuously (step, S15). The processor may determine whether to charge the battery completely or charge the battery as much as an amount for cleaning the partition area. This is described in detail below.

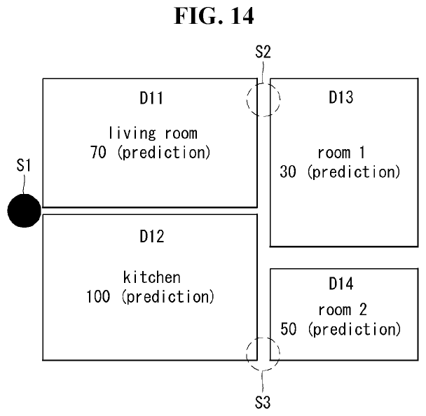

FIG. 14 is a diagram for describing a consumption of battery power predicted for each partition area according to an embodiment of the present disclosure.

Referring to FIG. 14, a target area may be partitioned into at least one partition area D11 to D14. The target area may be partitioned into a first partition area D11 to a fourth partition area D14.

In the case of a waiting state before cleaning, an artificial intelligence robot device may be charged in a charge station S1. The charge station S1 may be disposed between the first partition area D11 and the second partition area D12. But the present disclosure is not limited thereto, but the charge stations S2 and S3 may be disposed between the first partition area D11 and the third partition area D13 or disposed between the second partition area D12 and the fourth partition area D14, respectively.

The artificial intelligence robot device may change the driving route of the artificial intelligence robot device that drives through the partition areas D11 to D14 depending on locations of charge stations S1 to S3. Accordingly, the artificial intelligence robot device may configure or determine a driving route through at least one of the partition areas D11 to D14 considering the locations of charge stations S1 to S3.

The artificial intelligence robot device may predict the amount of battery power or the consumption of battery power for each of the partition areas D11 to D14 based on the learning result previously learned and considering peripheral environment, weather, time, and the like.

For example, in the case that the target area is a private house, the first partition area D11 may be a living room.

The first partition area D11 may be wider than the other partition areas D12 to D14, and many obstacles such as a sofa and a cabinet. Accordingly, the artificial intelligence robot device may predict the consumption of battery power as 70 in the case of cleaning the first partition area D11.

The second partition area D12 may be a kitchen. Different from the other partition areas D11, D13 and D14, many obstacles such as a wet trash like various types of trashes generated by various food materials, a table and a kitchen tool in the second partition area D12. Accordingly, the artificial intelligence robot device may predict the consumption of battery power as 60 in the case of cleaning the second partition area D12.

The third partition area D13 may be a big room. A fixed obstacle may be disposed in the third partition area D13, such as a bed and a wardrobe. Accordingly, the artificial intelligence robot device may predict the consumption of battery power as 50 in the case of cleaning the third partition area D13.

The fourth partition area D13 may be a small room. The fourth partition area D13 may have the smallest area, a fixed obstacle such as a bed, a desk and a bookshelf is disposed therein, manly used by a child. Accordingly, the artificial intelligence robot device may predict the consumption of battery power as 30 in the case of cleaning the fourth partition area D14.

For example, the charge station may charge (predict) the battery as much as 5 per minute, and the charge may be represented as 100 in the case that the battery is fully charged.

In the case that a battery of a conventional robot cleaner is fully charged with 100, the robot cleaner may clean the first partition area for which a consumption of battery power is 70 and the fourth partition area for which a consumption of battery power is 30 and may be returned and charged. The time during which the conventional robot cleaner is fully charged may be about 20 minutes.

Thereafter, in the case that the battery is charged with 100, the conventional robot cleaner may clean the second partition area for which a consumption of battery power is 60 and the third partition area for which a consumption of battery power is 50, but may be unable to clean a part of area of the second partition area, and may be returned and charged. The time during which the conventional robot cleaner is fully charged may be about 20 minutes.

Later, in the case that the battery is charged with 100, the conventional robot cleaner may clean the part of area of the second partition area which is uncleaned, and may be returned and charged, and then, finish cleaning.

As described above, the conventional robot cleaner requires a charging time of 40 minutes until cleaning is finished, and a moving time may be consumed to move through the partition areas.

Different from this, in the case that a battery of the artificial intelligence robot device according to an embodiment of the present disclosure is fully charged with 100, the artificial intelligence robot device may clean the first partition area for which a consumption of battery power is 70 and the fourth partition area for which a consumption of battery power is 30 and may be returned and charged. The time during which the artificial intelligence robot device is fully charged may be about 20 minutes.

Thereafter, in the case that the battery is fully charged with 100, the artificial intelligence robot device may clean the second partition area for which a consumption of battery power is 60 and the third partition area for which a consumption of battery power is 50, but may be unable to clean a part of area of the second partition area, and may be returned and charged. At this time, the artificial intelligence robot device may calculate or predict a consumption of the battery power for the part of area of the second partition area unable to clean, the battery may be partially charged, not fully charged. That is, artificial intelligence robot device may predict a consumption of battery power for the part of area of the second partition area to be 10, and the battery may be partially charged for 2 minutes based on the predicted consumption of battery power. And then, the artificial intelligence robot device may clean the part of area of the second partition area and may be returned and charged.

Therefore, the artificial intelligence robot device may require a charging time of 22 minutes until cleaning is finished and may require a moving time consumed to move through the partition areas.

As described above, the artificial intelligence robot device may finish cleaning faster than the conventional robot cleaner even in the case of cleaning the same area.

That is, according to the present disclosure, an optimal charging time is calculated using consumption/charge amount of a battery power which is previously learned, and the battery is completely or partially charged until all cleaning works are executed, and the cleaning time may be significantly reduced.

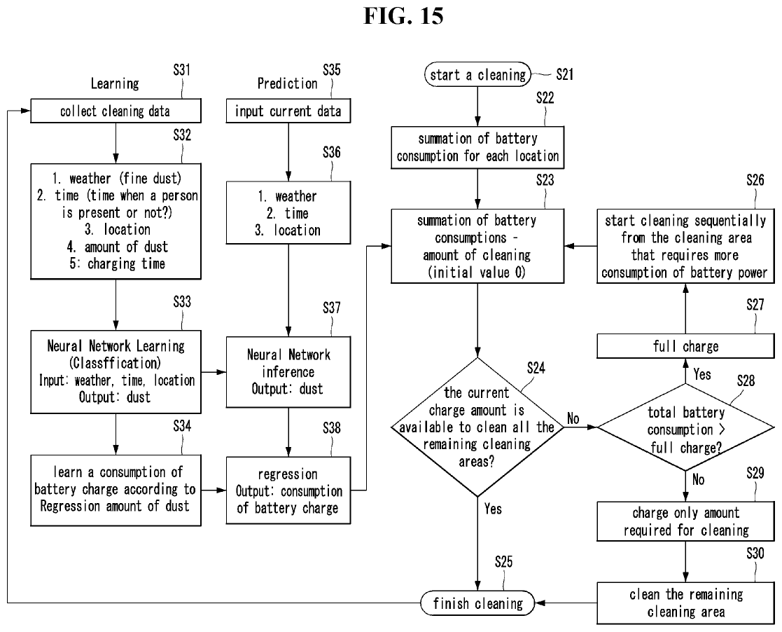

FIG. 15 is a diagram for describing an example of executing a cleaning work by using an artificial intelligence robot device according to an embodiment of the present disclosure.

Referring to FIG. 15, an artificial intelligence robot device may be switched from a waiting state to a cleaning state in a charge station.

When switched to the cleaning state, the artificial intelligence robot device may be turned on and start a cleaning (step, S21).

The artificial intelligence robot device may partition a cleaning area which is a preconfigured target area into at least one. The artificial intelligence robot device may predict a consumption of battery power for each location of the partitioned cleaning area and add the predicted consumption of battery powers (step, S22).

The artificial intelligence robot device may calculate an amount of cleaning of the cleaning area which is cleaned while cleaning the partitioned cleaning area based on the added consumption of battery powers. That is, the artificial intelligence robot device may check a remaining amount of battery power in real time by removing the calculated amount of cleaning from the added consumption of battery powers (step, S23). In the case that a value of the added consumption of battery powers subtracted by the calculated amount of cleaning is 0, the artificial intelligence robot device may set it as an initial value.

The artificial intelligence robot device may determine whether the remaining charge amount of the battery power is available to clean a remaining cleaning area (step, S24). That is, the artificial intelligence robot device may check a charge remaining state of the battery, and based on it, may determine whether to drive completely through a driving route of the cleaning area.

In the case that the artificial intelligence robot device determines that it is available to drive completely through a driving route of the cleaning area based on the charge remaining state of the battery (step, S24), the artificial intelligence robot device may clean all cleaning areas and finish cleaning (step, S25).

In the case that the artificial intelligence robot device determines that it is unavailable to drive completely through a driving route of the cleaning area based on the charge remaining state of the battery (step, S24), the artificial intelligence robot device may compare the added consumption of battery powers with a fully charged state of the battery (step, S28). In the case that the artificial intelligence robot device determines the added consumption of battery powers is greater than the fully charged state of the battery (step, S28), the artificial intelligence robot device may control to fully charge the battery (step, S27). The artificial intelligence robot device may start cleaning sequentially from the cleaning area that requires more consumption of battery power by using the fully charged battery (step, S26).

Later, the artificial intelligence robot device may check a remaining amount of battery power in real time by removing the calculated amount of cleaning from the added consumption of battery powers (step, S23).

In addition, in the case that the artificial intelligence robot device determines the added consumption of battery powers is relatively smaller than the fully charged state of the battery (step, S28), the artificial intelligence robot device may control to charge the battery as much as a charge amount required for cleaning (step, S29). That is, the artificial intelligence robot device may charge the charge amount required for cleaning in the battery based on the consumption of battery power which is consumed in the cleaning area to be cleaned.

Later, the artificial intelligence robot device may clean the remaining cleaning area (step, S30). After cleaning all the remaining cleaning areas, the artificial intelligence robot device may finish cleaning (step, S25).

When the cleaning is finished, the artificial intelligence robot device may collect driving information which is acquired while driving through the cleaning areas (step, S31). The driving information may include cleaning data or cleaning information.

The artificial intelligence robot device may collect various types of the acquired cleaning information related to cleaning such as a weather, a time, a location, an amount of dust, a charging time, and the like, and may learn and store the information (step, S32).

For example, the artificial intelligence robot device may recognize a presence of fine dust, a wind strength, a weather state, a temperature, and the like through the weather data among the collected cleaning information and may recognize whether the time is a time when a person is present through the time data.

The artificial intelligence robot device may derive a result of neural network through a Neural Network Learning (step, S33). The result of neural network may be shown as a result of classification and regression. For example, the classification is used for finding a class of data, and the regression is used for predicting a number in consecutive input data. For example, the artificial intelligence robot device may classify a weather, a time and a location as input data and may classify a dust as an output data. In addition, the artificial intelligence robot device may learn a number for a consumption of battery charge according to an amount of dust through the consecutive input/output data and predict it (step, S34).

As described above, the artificial intelligence robot device may input a current data (step, S35). The current data may be data in relation to a weather, a time and a location (step, S36). The artificial intelligence robot device may apply the current data to the Neural Network Learning and may predict a number for a dust or an amount of dust (step, S37).

The artificial intelligence robot device may predict or extract a consumption of battery power for each cleaning area by using the current data and the predicted data for dust (step, S38).

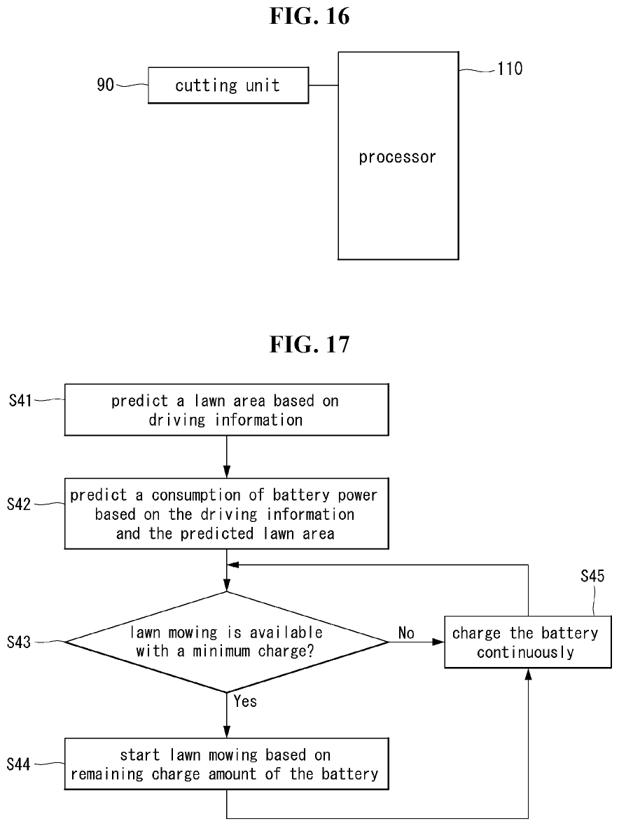

FIG. 16 is a diagram for describing another example of a configuration of an artificial intelligence robot device according to an embodiment of the present disclosure.

Referring to FIG. 16, a configuration of an artificial intelligence robot device according to an embodiment of the present disclosure may be substantially the same as the configuration of the artificial intelligence robot device described in FIG. 7. In FIG. 16, the configuration not described in FIG. 7 is mainly described.

Referring to FIG. 16, a processor 110 may include an application processor (AP) that performs a function of managing an entire hardware module system of the artificial intelligence robot device 100. The AP may perform an application program execution for driving using location information acquired through various types of sensors and execution of motor by transmitting user input/output information to a MICOM. A cutting unit 90 may be managed by the AP.

The artificial intelligence robot device 100 may apply a deep learning model through an AI device and implement the functions of image analysis of an object obtained through an image acquisition unit (160; refer to FIG. 7), a location recognition of the object and an obstacle recognition. The detailed description therefor is omitted since it is described in FIG. 8.

The cutting unit 90 may drive a motor under a control of the processor 110. A saw blade may be installed at an end of the motor and cut grass while rotating by driving the motor. The saw blade may have various shapes. For example, the saw blade may be a circular saw blade.

FIG. 17 is a diagram for describing an example of briefly executing a lawn mowing cleaning work by using an artificial intelligence robot device according to an embodiment of the present disclosure.

Referring to FIG. 17, a processor may predict a lawn area for a partition area based on driving information (step, S41). For example, the driving information may include a movement value for which a wheel installed in the artificial intelligence robot device and the artificial intelligence robot device move. These may be learning elements. For example, among the driving information, the wheel may be information for a size of the wheel installed in the artificial intelligence robot device and the number of revolutions of the wheel. Among the driving information, a movement value may be information for a moving distance or time moved by the artificial intelligence robot device. The processor may predict a lawn area for each partition area based on a driving element or a learning element.

The processor may predict a consumption of battery power consumed while driving through a driving route which is configured in a partition area based on the driving information and the predicted lawn area (step, S42). The consumption of battery power may be referred to as a decrement of battery power. In other words, the processor may predict an amount of battery power used while driving through a driving route which is configured in a partition area based on the driving information and the predicted lawn area. Accordingly, the processor may recognize or calculate a charge remaining state in the battery by using amount information of battery power and the predicted amount of battery power or the consumption of battery power.

The processor may learn information for the obtained size of the wheel, the number of revolutions of the wheel, a moving distance, a moving time, and the like and predict the lawn area based on the learned information. The processor may learn the amount of battery power or the consumption of battery power based on the predicted lawn area and predict it.

The processor may determine whether to perform a lawn mowing of at least one partition area among the partition areas based on the calculated or recognized charge remaining state in the battery (step, S43). That is, the processor may determine whether to perform a lawn mowing of one partition area among the partition areas with a minimum charge which is charged in the battery.

In the case that the processor determines that the determined remaining charge amount of the battery is available to perform a lawn mowing of at least one partition area (step, S43), the processor may move the artificial intelligence robot device to the partition area and start cleaning (step, S44).

On the other hand, in the case that the processor determines that the determined remaining charge amount of the battery is unavailable to perform a lawn mowing of at least one partition area (step, S43), the processor may charge the battery continuously (step, S45). The processor may determine whether to charge the battery completely or charge the battery as much as an amount for lawn mowing of the partition area. This is described in detail below.

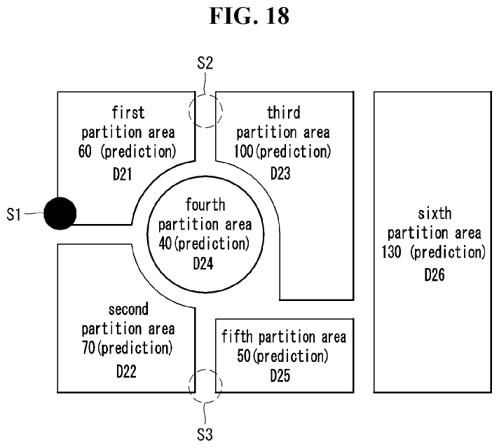

FIG. 18 is a diagram for describing a consumption of battery power predicted for each partition area according to an embodiment of the present disclosure.

Referring to FIG. 18, a target area may be partitioned into at least one partition area D21 to D24. The target area may be partitioned into a first partition area D21 to a sixth partition area D26.

In the case of a waiting state before lawn mowing, an artificial intelligence robot device may be charged in a charge station S1. The charge station S1 may be disposed between the first partition area D21 and the second partition area D22. But the present disclosure is not limited thereto, but the charge stations S2 and S3 may be disposed between the first partition area D21 and the third partition area D23 or disposed between the second partition area D22 and the fifth partition area D25, respectively.

The artificial intelligence robot device may change the driving route of the artificial intelligence robot device that drives through the partition areas D21 to D26 depending on locations of charge stations S1 to S3. Accordingly, the artificial intelligence robot device may configure or determine a driving route through at least one of the partition areas D21 to D26 considering the locations of charge stations S1 to S3.

The artificial intelligence robot device may predict the amount of battery power or the consumption of battery power for each of the partition areas D21 to D26 based on the learning result previously learned and considering a wheel, a movement value, and the like.

For example, in the case that the target area is a yard, the first partition area D21 may be disposed at a top left side of the yard. The artificial intelligence robot device may predict the consumption of battery power as 60 in the case of lawn mowing of the first partition area D21. The second partition area D22 may be disposed at a bottom left side of the yard. The artificial intelligence robot device may predict the consumption of battery power as 70 in the case of lawn mowing of the second partition area D22. The third partition area D23 may be disposed at a top center of the yard. The artificial intelligence robot device may predict the consumption of battery power as 100 in the case of lawn mowing of the third partition area D23. The fifth partition area D25 may be disposed at a bottom center of the yard. The artificial intelligence robot device may predict the consumption of battery power as 50 in the case of lawn mowing of the fifth partition area D25. The fourth partition area D24 may be disposed at a center of the yard but may be surrounded by the first partition area D21, the second partition area D22, the third partition area D23 and the fifth partition area D25. The artificial intelligence robot device may predict the consumption of battery power as 40 in the case of lawn mowing of the fourth partition area D24. The sixth partition area D26 may be disposed at a right side of the yard. The artificial intelligence robot device may predict the consumption of battery power as 130 in the case of lawn mowing of the sixth partition area D26.

Since the description for lawn mowing through the driving route established for each of the first partition area to the six partition area is sufficiently described in FIG. 14, the description is omitted herein.

As described above, according to the present disclosure, an optimal charging time is calculated using consumption/charge amount of a battery power which is previously learned, and the battery is completely or partially charged until all lawn mowing works are executed, and the cleaning time may be significantly reduced.

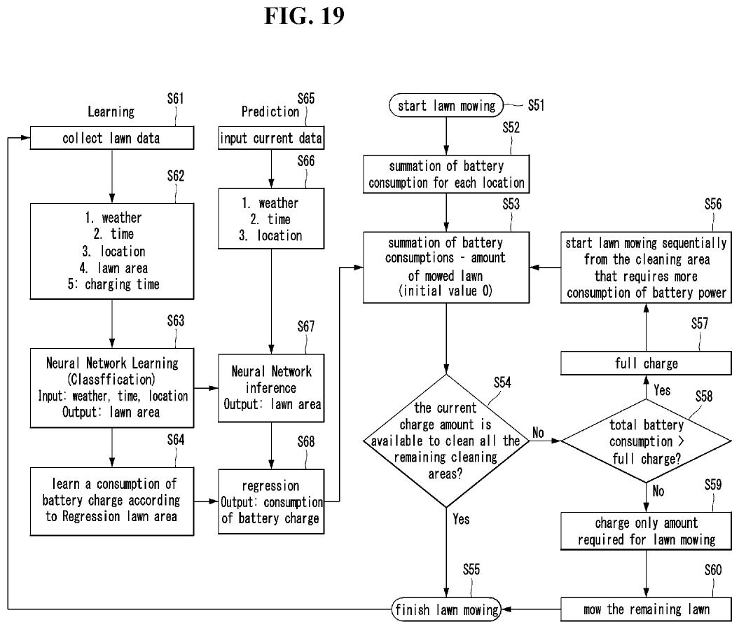

FIG. 19 is a diagram for describing an example of executing a lawn mowing work by using an artificial intelligence robot device according to an embodiment of the present disclosure.

Referring to FIG. 19, an artificial intelligence robot device may be switched from a waiting state to a lawn mowing state in a charge station.

When switched to the lawn mowing state, the artificial intelligence robot device may be turned on and start a lawn mowing (step, S51).

The artificial intelligence robot device may partition a lawn area which is a preconfigured target area into at least one. The artificial intelligence robot device may predict a consumption of battery power for each location of the partitioned lawn area and add the predicted consumption of battery powers (step, S52).

The artificial intelligence robot device may calculate an amount of lawn of the lawn area which is mowed while mowing the partitioned lawn area based on the added consumption of battery powers. The amount of lawn may be referred to an amount of lawn which is mowed.

That is, the artificial intelligence robot device may check a remaining amount of battery power in real time by removing the calculated amount of lawn from the added consumption of battery powers (step, S53). In the case that a value of the added consumption of battery powers subtracted by the calculated amount of lawn is 0, the artificial intelligence robot device may set it as an initial value.

The artificial intelligence robot device may determine whether the remaining charge amount of the battery power is available to clean a remaining lawn area (step, S54). That is, the artificial intelligence robot device may check a charge remaining state of the battery, and based on it, may determine whether to drive completely through a driving route of the lawn area.

In the case that the artificial intelligence robot device determines that it is available to drive completely through a driving route of the lawn area based on the charge remaining state of the battery (step, S54), the artificial intelligence robot device may mow all lawn areas and finish mowing (step, S55).

In the case that the artificial intelligence robot device determines that it is unavailable to drive completely through a driving route of the lawn area based on the charge remaining state of the battery (step, S54), the artificial intelligence robot device may compare the added consumption of battery powers with a fully charged state of the battery (step, S58). In the case that the artificial intelligence robot device determines the added consumption of battery powers is greater than the fully charged state of the battery (step, S58), the artificial intelligence robot device may control to fully charge the battery (step, S57). The artificial intelligence robot device may start mowing sequentially from the lawn area that requires more consumption of battery power by using the fully charged battery (step, S56).

Later, the artificial intelligence robot device may check a remaining amount of battery power in real time by removing the calculated amount of mowing from the added consumption of battery powers (step, S53).

In addition, in the case that the artificial intelligence robot device determines the added consumption of battery powers is relatively smaller than the fully charged state of the battery (step, S58), the artificial intelligence robot device may control to charge the battery as much as a charge amount required for cleaning (step, S59). That is, the artificial intelligence robot device may charge the charge amount required for mowing in the battery based on the consumption of battery power which is consumed in the lawn area to be mowed.

Later, the artificial intelligence robot device may mow the remaining lawn area (step, S60). After mowing all the remaining lawn areas, the artificial intelligence robot device may finish lawn mowing (step, S55).

When the lawn mowing is finished, the artificial intelligence robot device may collect driving information which is acquired while driving through the lawn areas (step, S61). The driving information may include data related to a wheel or data of moving distance or moving time.

The artificial intelligence robot device may collect various types of the acquired lawn information such as a wheel, a movement value, a lawn area, a charging time, and the like and may learn and store the information (step, S62).

For example, the artificial intelligence robot device may recognize a wheel installed in the artificial intelligence robot device, a size of the wheel, the number of revolutions of the wheel, a moving distance, a moving time, and the like among the collected lawn information.

The artificial intelligence robot device may derive a result of neural network through a Neural Network Learning (step, S63). The result of neural network may be shown as a result of classification and regression. For example, the classification is used for finding a class of data, and the regression is used for predicting a number in consecutive input data. For example, the artificial intelligence robot device may classify a wheel and a movement value as input data and may classify a lawn area as an output data. In addition, the artificial intelligence robot device may learn a number for a consumption of battery charge according to a lawn area through the consecutive input/output data and predict it (step, S64).

As described above, the artificial intelligence robot device may input a current data (step, S65). The current data may be data in relation to a wheel and a movement value (step, S66). The artificial intelligence robot device may apply the current data to the Neural Network Learning and may predict a number for a lawn or a lawn area (step, S67).

The artificial intelligence robot device may predict or extract a consumption of battery power for each partitioned lawn area by using the current data and the predicted data for a lawn area (step, S68).

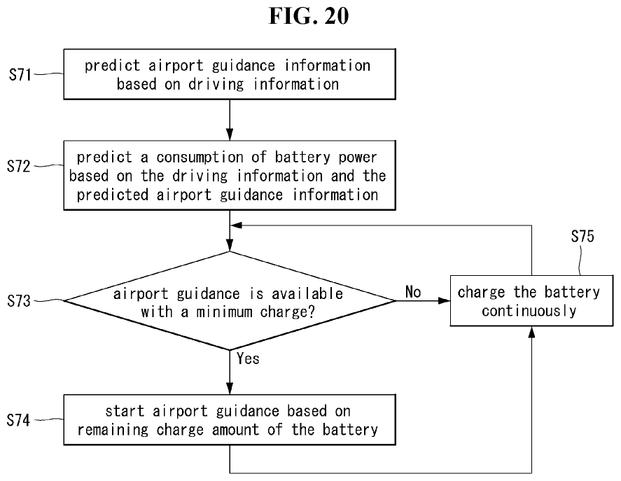

FIG. 20 is a diagram for describing an example of briefly executing an airport guidance work by using an artificial intelligence robot device according to an embodiment of the present disclosure.

Referring to FIG. 20, a processor may predict an airport guidance or an airport guidance time for a partition area based on driving information (step, S71). For example, the driving information may include a time, a location and an airport guidance. These may be learning elements. For example, among the driving information, the time may be information for a flight time, a takeoff time of an airplane and a landing time of an airplane. Among the driving information, the location may be information for a current location of driving in an airport. The processor may predict an airport guidance or an airport guidance time for each partition area based on a driving element or a learning element.

The processor may predict a consumption of battery power consumed while driving through a driving route which is configured in a partition area based on the driving information and the predicted airport guidance or the airport guidance time (step, S72). The consumption of battery power may be referred to as a decrement of battery power. In other words, the processor may predict an amount of battery power used while driving through a driving route which is configured in a partition area based on the driving information and the predicted airport guidance or the airport guidance time. Accordingly, the processor may recognize or calculate a charge remaining state in the battery by using amount information of battery power and the predicted amount of battery power or the consumption of battery power.

The processor may learn information for the obtained flight time, the takeoff time of an airplane, the landing time of an airplane, a current location of driving in an airport, and the like and predict the airport guidance or the airport guidance time based on the learned information. The processor may learn the amount of battery power or the consumption of battery power based on the predicted airport guidance or the airport guidance time and predict it.

The processor may determine whether to perform a lawn mowing of at least one partition area among the partition areas based on the calculated or recognized charge remaining state in the battery (step, S43). That is, the processor may determine whether to perform an airport guidance of one partition area among the partition areas with a minimum charge which is charged in the battery.

In the case that the processor determines that the determined remaining charge amount of the battery is available to perform an airport guidance of at least one partition area (step, S73), the processor may move the artificial intelligence robot device to the partition area and start an airport guidance (step, S74).

On the other hand, in the case that the processor determines that the determined remaining charge amount of the battery is unavailable to perform an airport guidance of at least one partition area (step, S73), the processor may charge the battery continuously (step, S45). The processor may determine whether to charge the battery completely or charge the battery as much as an amount for an airport guidance of the partition area. This is described in detail below.

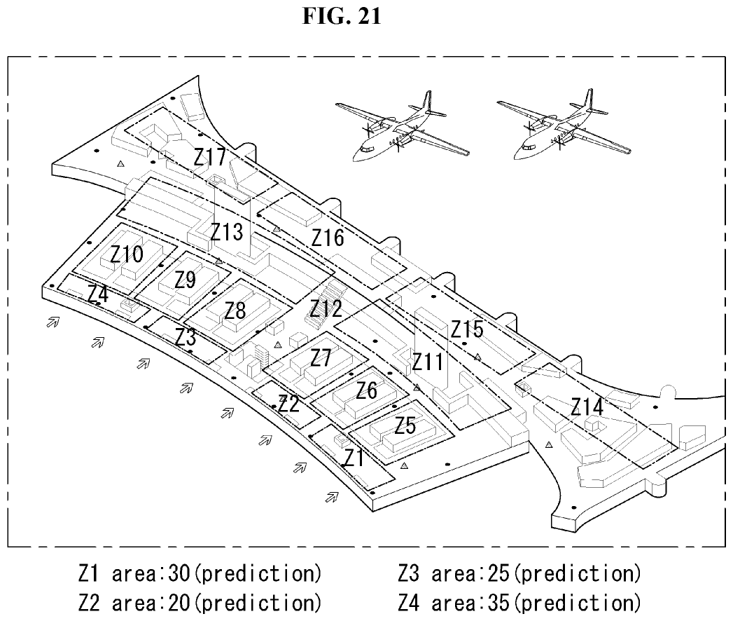

FIG. 21 is a diagram for describing a consumption of battery power predicted for each partition area according to an embodiment of the present disclosure.

Referring to FIG. 21, a target area may be partitioned into at least one partition area Z1 to Z17. The target area may be partitioned into a first partition area Z1 to a seventeenth partition area Z17.

In the case of a waiting state before performing an airport guidance, an artificial intelligence robot device may be charged in a charge station. The charge station may be disposed in each of the first partition area Z1 to the seventeenth partition area Z17.

The artificial intelligence robot device may change the driving route of the artificial intelligence robot device that drives through the partition areas Z1 to Z17 depending on locations of charge stations.

The artificial intelligence robot device may predict the amount of battery power or the consumption of battery power for each of the partition areas Z1 to Z17 based on the learning result previously learned and considering a flight time, a takeoff time of an airplane, a landing time of an airplane, a current location of driving in an airport, and the like.

Since the description for performing an airport guidance through the driving route established for each of the first partition area to the seventeenth partition area is sufficiently described in FIG. 14, the description is omitted herein.

As described above, according to the present disclosure, an optimal charging time is calculated using consumption/charge amount of a battery power which is previously learned, and the battery is completely or partially charged until all airport guidance works are executed, and the airport guidance may be efficiently performed.

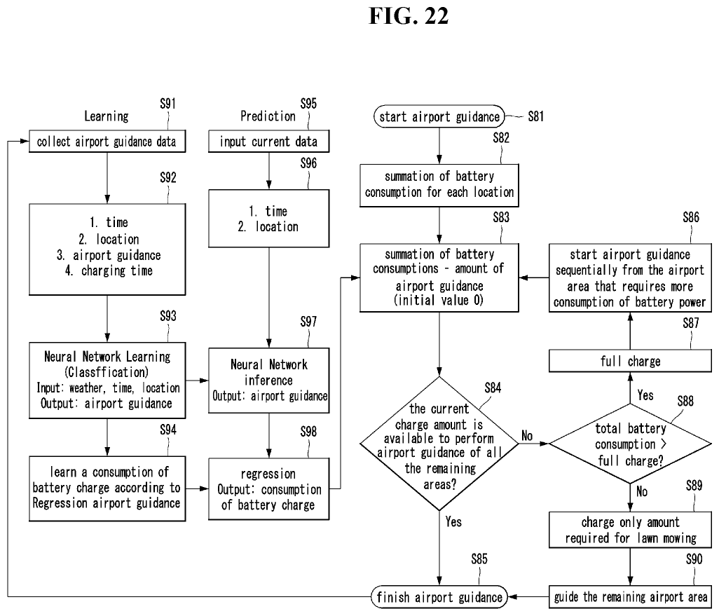

FIG. 22 is a diagram for describing an example of executing an airport guidance work by using an artificial intelligence robot device according to an embodiment of the present disclosure.

Referring to FIG. 22, an artificial intelligence robot device may be switched from a waiting state to an airport guiding state in a charge station.

When switched to the airport guiding state, the artificial intelligence robot device may be turned on and start an airport guidance (step, S81).

The artificial intelligence robot device may partition an airport which is a preconfigured target area into at least one. The artificial intelligence robot device may predict a consumption of battery power for each location of the partitioned airport area and add the predicted consumption of battery powers (step, S82).

The artificial intelligence robot device may calculate an airport guidance time while performing an airport guidance in the partitioned lawn area based on the added consumption of battery powers. That is, the artificial intelligence robot device may check a remaining amount of battery power in real time by removing the calculated airport guidance time from the added consumption of battery powers (step, S83). In the case that a value of the added consumption of battery powers subtracted by the calculated airport guidance time is 0, the artificial intelligence robot device may set it as an initial value.

The artificial intelligence robot device may determine whether the remaining charge amount of the battery power is available to perform an airport guidance of a remaining airport area (step, S84). That is, the artificial intelligence robot device may check a charge remaining state of the battery, and based on it, may determine whether to drive completely through a driving route of the airport area.

In the case that the artificial intelligence robot device determines that it is available to drive completely through a driving route of the airport area based on the charge remaining state of the battery (step, S84), the artificial intelligence robot device may perform an airport guidance for all airport areas and finish the guidance (step, S85).

In the case that the artificial intelligence robot device determines that it is unavailable to drive completely through a driving route of the airport area based on the charge remaining state of the battery (step, S84), the artificial intelligence robot device may compare the added consumption of battery powers with a fully charged state of the battery (step, S88). In the case that the artificial intelligence robot device determines the added consumption of battery powers is greater than the fully charged state of the battery (step, S88), the artificial intelligence robot device may control to fully charge the battery (step, S87). The artificial intelligence robot device may start an airport guidance sequentially from the airport area that requires more consumption of battery power by using the fully charged battery (step, S86).

Later, the artificial intelligence robot device may check a remaining amount of battery power in real time by removing the calculated airport guidance time from the added consumption of battery powers (step, S83).

In addition, in the case that the artificial intelligence robot device determines the added consumption of battery powers is relatively smaller than the fully charged state of the battery (step, S88), the artificial intelligence robot device may control to charge the battery as much as a charge amount as required (step, S89). That is, the artificial intelligence robot device may charge the required charge amount in the battery based on the consumption of battery power which is consumed in the airport area.

Later, the artificial intelligence robot device may mow the remaining airport area (step, S90). After performing airport guidance in all the remaining airport areas, the artificial intelligence robot device may finish the airport guidance (step, S85).

When the airport guidance is finished, the artificial intelligence robot device may collect driving information which is acquired while driving through the airport areas (step, S91). The driving information may include data related to a time or data related to a location.

The artificial intelligence robot device may collect various types of the acquired airport information such as a time, a location, and the like and may learn and store the information (step, S92). For example, the artificial intelligence robot device may recognize a flight time, a takeoff time of an airplane, a landing time of an airplane, a current location of driving in an airport, and the like, and the like among the collected airport information.

The artificial intelligence robot device may derive a result of neural network through a Neural Network Learning (step, S63). The result of neural network may be shown as a result of classification and regression. For example, the classification is used for finding a class of data, and the regression is used for predicting a number in consecutive input data. For example, the artificial intelligence robot device may classify a time and a location as input data and may classify an airport guidance as an output data. In addition, the artificial intelligence robot device may learn a number for a consumption of battery charge according to the airport area through the consecutive input/output data and predict it (step, S94).

As described above, the artificial intelligence robot device may input a current data (step, S95). The current data may be data in relation to a time and a location (step, S96). The artificial intelligence robot device may apply the current data to the Neural Network Learning and may predict a number for an airport guidance or an airport guidance time (step, S97).

The artificial intelligence robot device may predict or extract a consumption of battery power for each partitioned airport area by using the current data and the predicted data an airport guidance or an airport guidance time (step, S98).

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

The technical effects of the method for controlling an artificial intelligence robot device are as below.

According to the present disclosure, an optimal charging time is calculated using consumption/charge amount of a battery which is previously learned, and the battery is completely or partially charged until all of tasks are executed, and a task is efficiently performed.

According to the present disclosure, an optimal charging time is calculated using consumption/charge amount of a battery power which is previously learned, and the battery is completely or partially charged until all of tasks are executed, and a working time is significantly reduced.

Effects which may be obtained by the present disclosure are not limited to the effects described above, and other technical effects not described above may be evidently understood by a person having ordinary skill in the art to which the present disclosure pertains from the following description.

What is claimed is:

1. A method for controlling an artificial intelligence robot device, comprising:
identifying capacity information of a battery;
obtaining driving information for at least one driving route for driving a target area;
predicting power information of the battery of which power is consumed during moving through the driving route based on the obtained driving information and the capacity information of the battery;
determining whether the driving route is completed based on a charge remaining state in the battery calculated by analyzing the predicted power information; and
determining the driving route based on whether the driving route is completed.

2. The method of claim 1, wherein the capacity information of the battery includes at least one of a life of the battery, a voltage of the battery, a charging time of the battery and a discharging time of the battery.

3. The method of claim 1, wherein the step of obtaining driving information further includes:
obtaining map information;
configuring a target area in the obtained map information;
configuring a partition area by partitioning the target area;
configuring the driving route based on the partition area; and
obtaining driving information for the configured driving route.

4. The method of claim 3, wherein the driving route is differently configured corresponding to a task of the artificial intelligence robot device.

5. The method of claim 3, wherein the step of configuring the partition area includes:
partitioning the partition area based on a preconfigured partition criterion,
wherein the preconfigured partition criterion includes at least one of an area, a moving distance and an accessibility.

6. The method of claim 1, wherein the step of determining whether the driving route is completed further includes:
extracting feature values from the power information obtained through at least one sensor; and
inputting the feature values in an artificial neural network (ANN) sorter trained to identify whether the driving route is a completed route and determining whether the driving route is completed based on an output of the ANN.

7. The method of claim 5, wherein the feature values are values that distinguish whether the driving route is completed based on the charge remaining state in the battery.

8. The method of claim 1, wherein the driving information includes at least one of peripheral environment of the driving route, a position of an obstacle, a slope of the driving route and a material of the driving route.

9. The method of claim 1, further comprising:
receiving Downlink Control Information (DCI) used for scheduling a transmission of the power information obtained from at least one sensor provided in the artificial intelligence robot device from a network,
wherein the power information is transmitted to the network based on the DCI.

10. The method of claim 9, further comprising:
performing an initial access process with the network based on Synchronization signal block (SSB),
wherein the power information is transmitted to the network through a PUSCH, and
wherein the SSB and a DM-RS of the PUSCH are QCLed with respect to QCL type D.

11. The method of claim 9, further comprising:
controlling a transceiver to transmit the power information to an AI processor included in the network; and
controlling the transceiver to receive AI processed information from the AI processor,
wherein the AI processed information is information of determining the charge remaining state in the battery.
